(19) United States
(12) Patent Application Publication
(10) Pub. No.: US 2022/0406078 A1
(43) Pub. Date: Dec. 22, 2022

(54) METHOD AND APPARATUS FOR PROCESSING LANE LINE

(71) Applicant: BEIJING BAIDU NETCOM SCIENCE TECHNOLOGY CO., LTD., BEIJING (CN)

(72) Inventors: Yinghai WU, Beijing (CN); Yaqian SHEN, Beijing (CN); Jie ZHANG, Beijing (CN); Yi SU, Beijing (CN); Zhidong YIN, Beijing (CN)

(73) Assignee: BEIJING BAIDU NETCOM SCIENCE TECHNOLOGY CO., LTD., Beijing (CN)

(21) Appl. No.: 17/893,538

(22) Filed: Aug. 23, 2022

(30) Foreign Application Priority Data
Mar. 22, 2022 (CN) 2022102844146

(51) Int. Cl. G06V 20/56; G06V 10/80; G06V 10/75; G06T 7/13; G06T 7/60; G06T 7/50; G06T 7/73

(52) U.S. Cl. CPC G06V 20/588; G06V 10/803; G06V 10/751; G06T 7/13; G06T 7/60; G06T 7/50; G06T 7/74; G06T 2207/10028; G06T 2207/30242; G06T 2207/30256; G06T 2207/20221

(57) ABSTRACT

The present disclosure provides a method and an apparatus for processing a lane line, and relates to the field of data processing and, in particular, to the fields of intelligent transportation, Internet of Vehicles and intelligent cockpit. A specific implementation scheme is: obtaining a lane edge line of a road and a lane dividing line of the road according to point cloud data and image information of the road; acquiring breakpoints of the lane edge line, and acquiring breakpoints of the lane dividing line; completing the lane edge line according to the breakpoints of the lane edge line, to obtain a continuous lane edge line; completing the lane dividing line according to the breakpoints of the lane dividing line and the continuous lane edge line, to obtain a continuous lane dividing line.

### CROSS-REFERENCE TO RELATED APPLICATIONS

This application claims priority to Chinese Patent Application No. 202210284414.6, filed on Mar. 22, 2022 and entitled “METHOD AND APPARATUS FOR PROCESSING LANE LINE”, which is hereby incorporated by reference in its entirety.

### TECHNICAL FIELD

The present disclosure relates to the fields of intelligent transportation, Internet of Vehicles and intelligent cockpit in the field of data processing and, in particular, to a method and an apparatus for processing a lane line.

### BACKGROUND

When performing data collection for a high-definition map, lane lines in the high-definition map may appear discontinuous due to vehicle occlusion and marking line abrasion.

At present, for the problem of discontinuous lane lines in the prior art, multiple rounds of data collection are usually performed again, and then splicing and fusion are performed according to data collected in the multiple rounds of data collection, so as to solve the occlusion problem, and thus realize completing of the discontinuous lane lines.

However, performing multiple rounds of data collection to complete the discontinuous lane lines may take a long time to generate a complete high-definition map.

### SUMMARY

The present disclosure provides a method and an apparatus for processing a lane line.

According to a first aspect of the present disclosure, a method for processing a lane line is provided, including:

obtaining a lane edge line of a road and a lane dividing line of the road according to point cloud data and image information of the road;

acquiring breakpoints of the lane edge line, and acquiring breakpoints of the lane dividing line;

completing the lane edge line according to the breakpoints of the lane edge line, to obtain a continuous lane edge line;

completing the lane dividing line according to the breakpoints of the lane dividing line and the continuous lane edge line, to obtain a continuous lane dividing line.

According to a second aspect of the present disclosure, an electronic device is provided, including:

at least one processor; and

a memory communicatively connected to the at least one processor; where,

the memory stores instructions executable by the at least one processor, and the instructions are executed by the at least one processor to enable the at least one processor to execute the method according to the first aspect.

According to a third aspect of the present disclosure, a non-transitory computer-readable storage medium having computer instructions stored thereon is provided, where the computer instructions are used to cause a computer to execute the method according to the first aspect.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF DRAWINGS

The drawings are used to better understand the solutions, and do not constitute a limitation on the present disclosure. Among them:

FIG. 1 is a schematic diagram of lane lines provided in an embodiment of the present disclosure.

### DISCLOSURE

FIG. 2 is a schematic diagram of discontinuous lane lines provided in an embodiment of the present disclosure.

FIG. 3 is a flowchart of a method for processing a lane line provided in an embodiment of the present disclosure.

FIG. 4 is a second flowchart of a method for processing a lane line provided in an embodiment of the present disclosure.

FIG. 5 is a first schematic diagram of a discontinuous lane edge line provided in an embodiment of the present disclosure.

FIG. 6 is a second schematic diagram of a discontinuous lane edge line provided in an embodiment of the present disclosure.

FIG. 7 is a schematic diagram of an implementation of a road segment provided in an embodiment of the present disclosure.

FIG. 8 is a first schematic diagram of an implementation of determining a target road sub-segment provided in an embodiment of the present disclosure.

FIG. 9 is a second schematic diagram of an implementation of determining a target road sub-segment provided in an embodiment of the present disclosure.

FIG. 10 is a first schematic diagram of an implementation of determining a shape reference point provided in an embodiment of the present disclosure.

FIG. 11 is a second schematic diagram of an implementation of determining a shape reference point provided in an embodiment of the present disclosure.

FIG. 12 is a third flowchart of a method for processing a lane line provided in an embodiment of the present disclosure.

FIG. 13 is a schematic diagram of a lane edge line pair provided in an embodiment of the present disclosure.

FIG. 14 is a schematic diagram of a condition that first curvature information is consistent with second curvature information provided in an embodiment of the present disclosure.

FIG. 15 is a schematic diagram of a condition that first curvature information is partially inconsistent with second curvature information provided in an embodiment of the present disclosure.

FIG. 16 is a first schematic diagram of an implementation of completing a lane dividing line provided in an embodiment of the present disclosure.

FIG. 17 is a second schematic diagram of an implementation of completing a lane dividing line provided in an embodiment of the present disclosure.

FIG. 18 is a third schematic diagram of an implementation of completing a lane dividing line provided in an embodiment of the present disclosure.

FIG. 19 is a fourth schematic diagram of an implementation of completing a lane dividing line provided in an embodiment of the present disclosure.

FIG. 20 is a fifth schematic diagram of an implementation of completing a lane dividing line provided in an embodiment of the present disclosure.

FIG. 21 is a sixth schematic diagram of an implementation of completing a lane dividing line provided in an embodiment of the present disclosure.

FIG. 22 is a schematic structural diagram of an apparatus for processing a lane line provided in an embodiment of the disclosure.

FIG. 23 is a block diagram of an electronic device used to implement a method for processing a lane line provided in an embodiment of the present disclosure.

### DESCRIPTION OF EMBODIMENTS

Exemplary embodiments of the present disclosure are described below with reference to the accompanying drawings, where various details of the embodiments of the present disclosure are included to facilitate understanding, and should be considered as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description.

In order to understand technical solutions of the present disclosure better, the related technologies involved in the present disclosure will be further introduced in detail below.

A high-definition map can play a dramatic role in driverless path planning, driverless positioning and other aspects. In order to make a high-definition map, it is usually necessary to collect relevant data. However, when performing data collection for a high-definition map, due to unavoidable situations such as vehicle occlusion, occlusion of other obstacles, and field marking line abrasion, etc., a problem of lane lines appearing discontinuous will be resulted in.

The lane line may usually include a lane edge line and a lane dividing line. Whether the lane edge line is discontinuous or the lane dividing line is discontinuous, the incompleteness of the lane line will affect an application effect of the high-definition map.

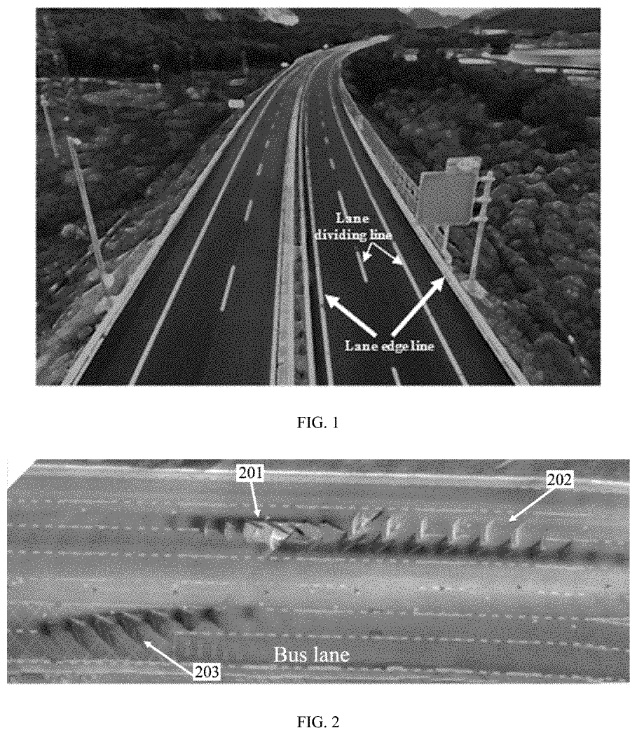

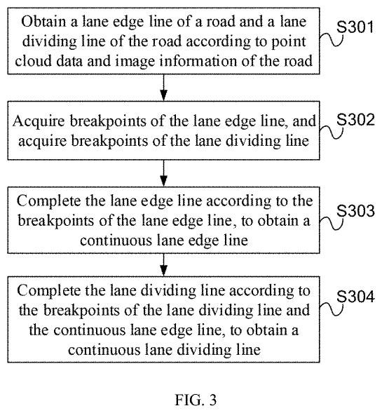

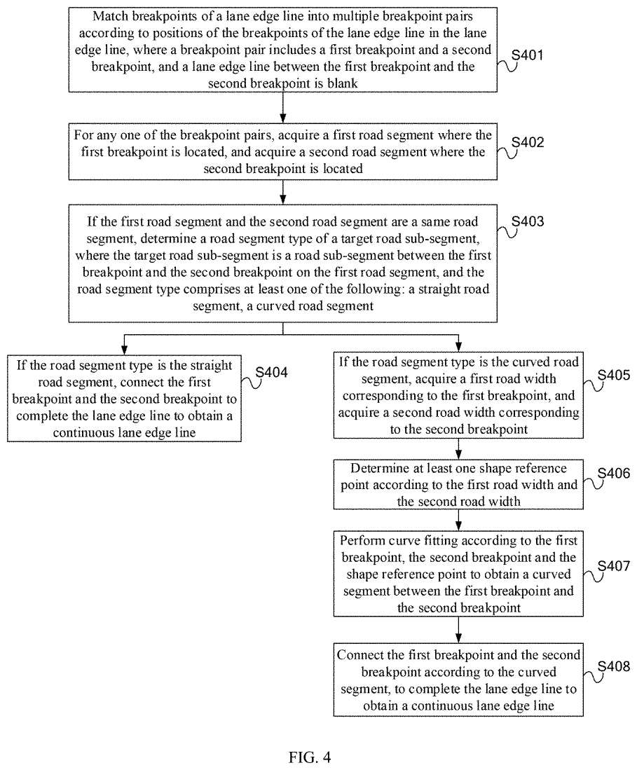

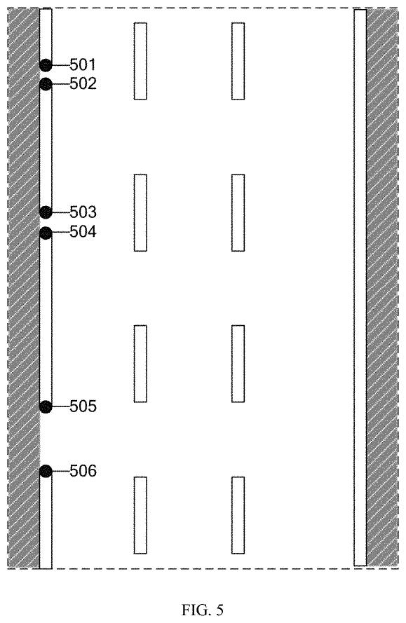

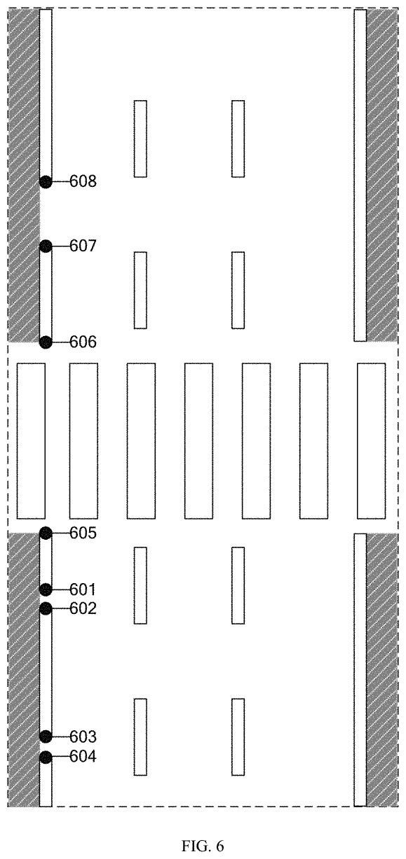

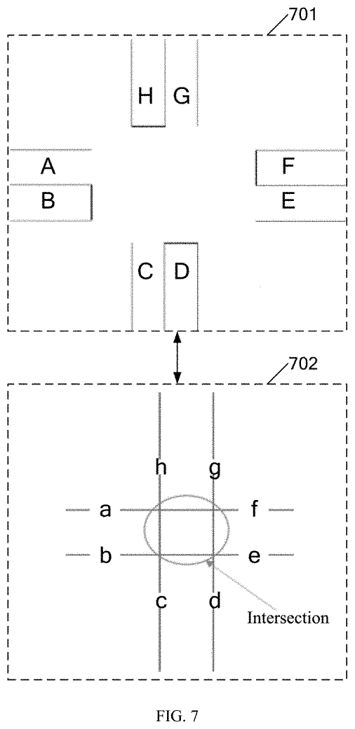

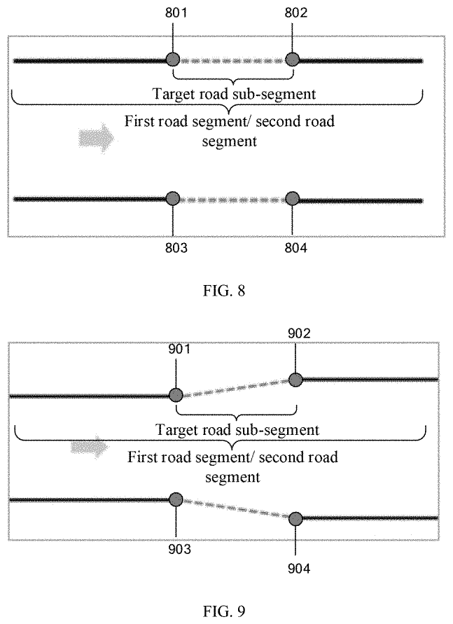

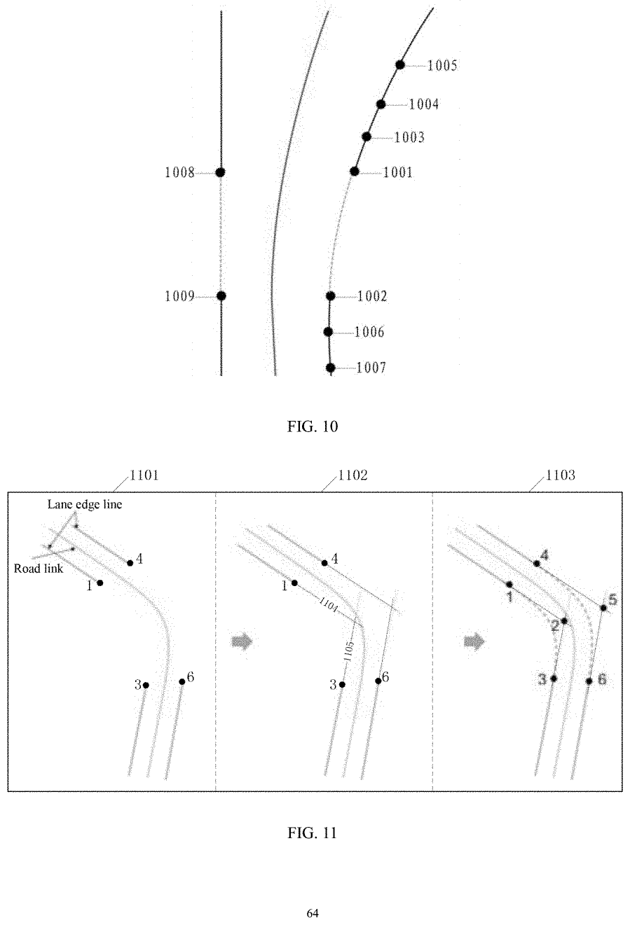

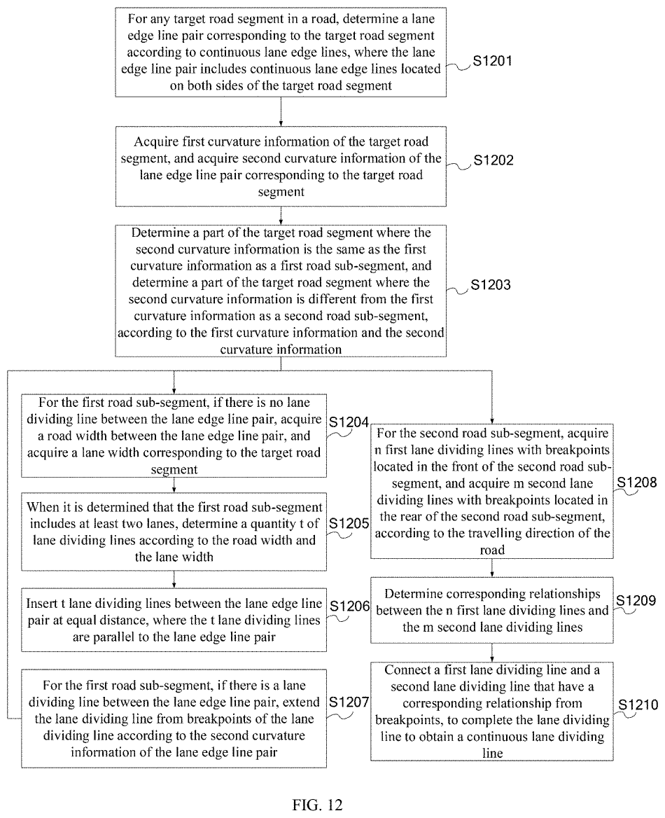

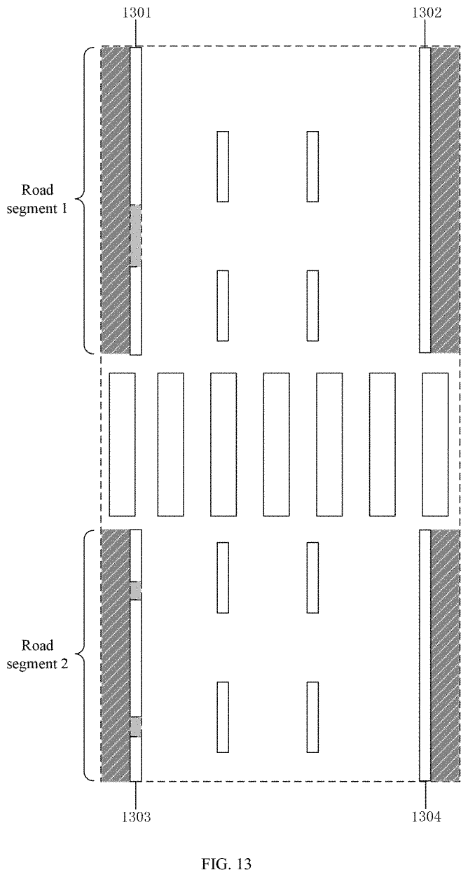

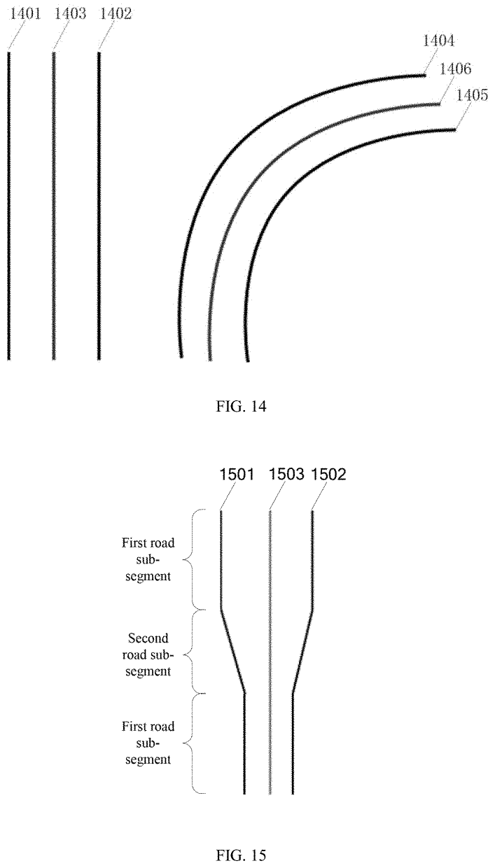

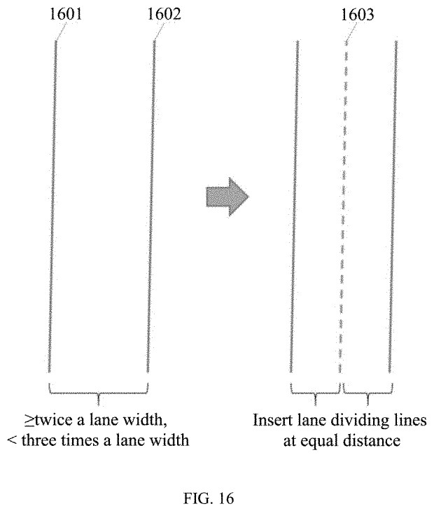

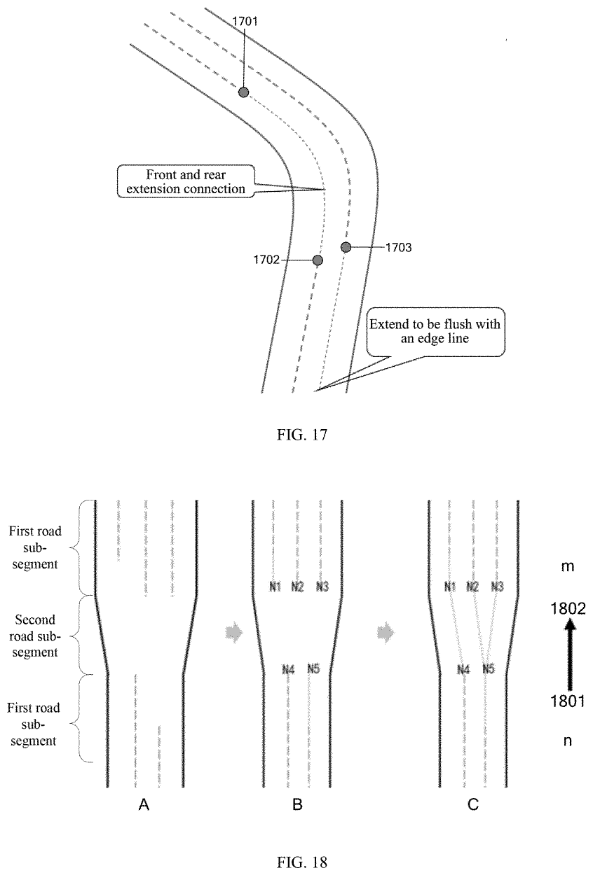

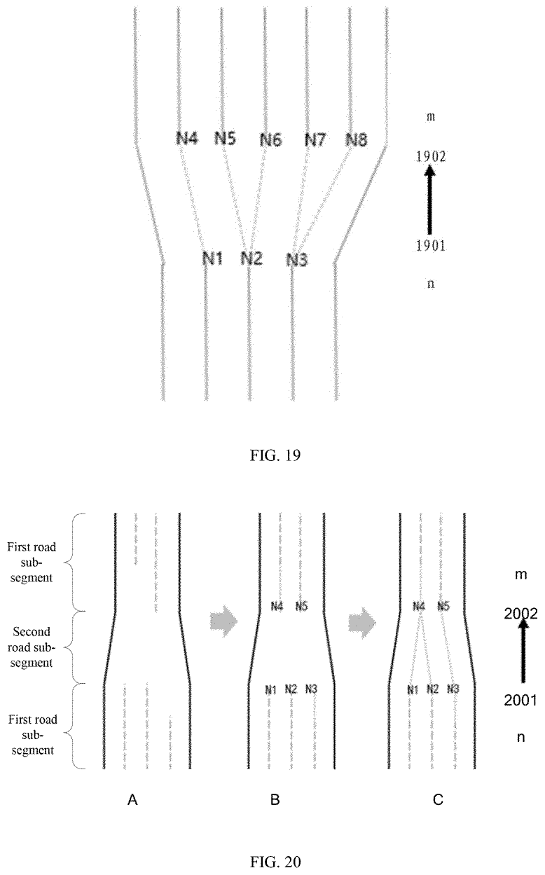

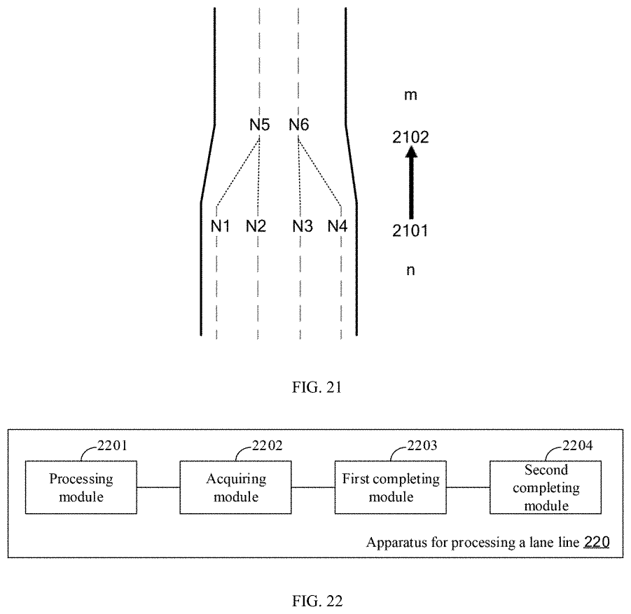

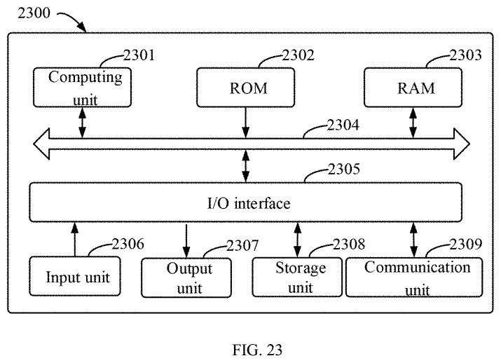

For example, referring to FIG. 1 and FIG. 2, the lane line and the discontinuity of the lane line can be understood. FIG. 1 is a schematic diagram of a lane line provided in an embodiment of the present disclosure, and FIG. 2 is a schematic diagram of a discontinuous lane line provided in an embodiment of the present disclosure.

As shown in FIG. 1, in a practical scenario, a lane line may usually include a lane edge line and a lane dividing line. The lane edge line is used to indicate an edge of a road, which is usually located at the most lateral position of the road, and the lane dividing line is usually used to distinguish different lanes.

Referring to FIG. 2, in the process of data collection, due to the occlusion of obstacles, in lane lines shown in FIG. 2, positions indicated by 201, 202 and 203 all appear to have discontinuity of the lane dividing line to varying degrees, and discontinuous lane lines may greatly reduce usability of the high-definition map.

At present, for the problem of discontinuous lane lines in the prior art, multiple rounds of data collection are usually performed again, and then splicing and fusion are performed according to data collected in the multiple rounds of data collection, so as to solve the occlusion problem, and thus realize completing of the discontinuous lane lines.

However, performing multiple rounds of data collection to complete the discontinuous lane lines may take a long time to generate a complete high-definition map. At the same time, for the abrasion of field marking lines, even if multiple rounds of data collection are performed, it is impossible to complete the discontinuous lane lines.

In addition, in the prior art, a large number of manual operations can also be used to complement missing lane lines.

However, investment to complement missing lane dividing lines manually is large, which will reduce production efficiency of the high-definition map. Especially on a common road, because a proportion of blurred or missing field marking lines is high, a high cost of data production will be caused.

For the problems in the prior art, the present disclosure proposes the following technical concept: by extracting breakpoints of the lane edge line and the lane dividing line, and analyzing various scenarios, to complete the lane edge line at the breakpoints of the lane edge line, and to also complete the lane dividing line based on the completed lane edge line, the discontinuous lane lines can be completed quickly and effectively, so as to shorten the consumed time for obtaining a complete high-definition map.

The technology according to the present disclosure solves the problem of taking a long time to generate a complete high-definition map.

Based on the content introduced above, the method for processing a lane line provided in the present disclosure will be introduced below with reference to specific embodiments. FIG. 3 is a flowchart of a method for processing a lane line provided in an embodiment of the present disclosure.

As shown in FIG. 3, the method includes:

S301: obtain a lane edge line of a road and a lane dividing line of the road according to point cloud data and image information of the road.

In the process of making a high-definition map, it is usually necessary to collect data for a road, where the collected data may include point cloud data of the road and image information of the road. In a possible implementation, the point cloud data and the image information may be collected by, for example, a sensor on a collecting vehicle, such as a radar sensor, an image sensor, etc.

After the point cloud data and the image information of the road are collected, the lane edge line of the road and the lane dividing line of the road can be identified according to the point cloud data of the road and the image information of the road.

In a possible implementation, for example, fusion processing can be performed according to the point cloud data of the road and the image information of the road, so as to obtain a fused image of the road, and the fused image can include the lane edge line and the lane dividing line of the road.

Afterwards, target extraction can be performed in the fused image to extract the lane edge line and the lane dividing line of the road.

It should be noted that in a practical scenario, there are many roads, and the road in this embodiment refers to a road on which data collection has been performed. That is to say, all roads, for which a high-definition map needs to be produced, and on which data collection is performed for the high-definition map, can be used as the road of this embodiment.

S302: acquire breakpoints of the lane edge line, and acquire breakpoints of the lane dividing line.

Because the lane edge line in this embodiment may have breakpoints, after the lane edge line in the road is extracted, the breakpoints of the lane edge line can be acquired. In a possible implementation, for example, based on the fused image obtained above, the breakpoints of each lane edge line can be extracted from the fused image.

And because the lane dividing line in this embodiment may have breakpoints, after the lane dividing line in the road is extracted, the breakpoints of the lane dividing line can be acquired, for example. In a possible implementation, for example, based on the fused image described above, the breakpoints of each lane dividing line can be extracted from the fused image.

The extraction of breakpoints may be implemented by, for example, color contrast, target identification, etc. An introduction in the related art may be referred to for the implementation of identifying specific points from an image, which is not limited in this embodiment.

It is explained here that the fused image not only includes synthesized image information of the lane dividing line and the lane edge line, but also includes data information of the lane dividing line and the lane edge line. The data information may include, for example, a coordinate position of each point of the lane dividing line, and a coordinate position of each point of the lane edge line. For the breakpoints of the lane edge line and the breakpoints of the lane dividing line acquired currently, not only can these breakpoints be extracted in the image, but also the coordinate positions of these breakpoints can be determined.

S303: complete the lane edge line according to the breakpoints of the lane edge line, to obtain a continuous lane edge line.

After the breakpoints of the lane edge line are obtained, for example, the lane edge line may be completed according to the breakpoints of the lane edge line. It can be understood that the completing of the lane edge line is actually to connect the breakpoints that need to be connected according to the direction of the road, so as to obtain a continuous lane edge line.

S304. complete the lane dividing line according to the breakpoints of the lane dividing line and the continuous lane edge line, to obtain a continuous lane dividing line.

After completing the lane edge line and obtaining the continuous lane edge line, in this embodiment, the lane dividing line may also be completed according to the breakpoints of the lane dividing line and the continuous lane edge line obtained above. The completing of the lane dividing line is similar to the above description, and similarly, the breakpoints that need to be connected are connected according to the direction of the road, so as to obtain a continuous lane dividing line.

By completing the lane edge line and lane dividing line, the problem of discontinuous lane lines can be effectively solved without re-collecting data, so as to obtain complete lane lines, thereby effectively improving the speed and efficiency of obtaining a complete high-definition map.

The method for processing a lane line provided in the embodiment of the present disclosure includes: obtaining a lane edge line of a road and a lane dividing line of the road according to point cloud data and image information of the road; acquiring breakpoints of the lane edge line, and acquire breakpoints of the lane dividing line; completing the lane edge line according to the breakpoints of the lane edge line, to obtain a continuous lane edge line; completing the lane dividing line according to the breakpoints of the lane dividing line and the continuous lane edge line, to obtain a continuous lane dividing line. The lane edge line and the lane dividing line are determined through the point cloud data and the image information, and then the breakpoints of the lane edge line and the breakpoints of the lane dividing line are extracted. Then the discontinuous part of the lane edge line is completed according to the breakpoints of the lane edge line to obtain the continuous lane edge line. After that, the discontinuous part of the lane dividing line is completed according to the breakpoints of the lane dividing line and the above-mentioned completed lane edge line, to obtain the continuous lane dividing line. In this way, it is possible to quickly and effectively complete the discontinuous parts of the lane lines based on the collected data to obtain complete lane lines, thereby effectively shortening the consumed time for obtaining a complete high-definition map.

On the basis of the above introduced content, it can be understood that the completing of the lane lines includes two parts. First, the lane edge line needs to be completed, and secondly, the lane dividing line needs to be completed. Specific implementations of the two parts of the completing of the lane lines will be introduced separately below with reference to specific embodiments.

Implementations of completing a lane edge line will be firstly introduced below with reference to FIG. 4 to FIG. 11. FIG. 4 is a second flowchart of a method for processing a lane line provided in an embodiment of the present disclosure; FIG. 5 is a first schematic diagram of a discontinuous lane edge line provided in an embodiment of the present disclosure; FIG. 6 is a second schematic diagram of a discontinuous lane edge line provided in an embodiment of the present disclosure; FIG. 7 is a schematic diagram of an implementation of a road segment provided in an embodiment of the present disclosure; FIG. 8 is a first schematic diagram of an implementation of determining a target road sub-segment provided in an embodiment of the present disclosure; FIG. 9 is a second schematic diagram of an implementation of determining a target road sub-segment provided in an embodiment of the present disclosure; FIG. 10 is a first schematic diagram of an implementation of determining a shape reference point provided in an embodiment of the present disclosure; and FIG. 11 is a second schematic diagram of an implementation of determining a shape reference point provided in an embodiment of the present disclosure.

As shown in FIG. 4, the method includes:

S401: match breakpoints of a lane edge line into multiple breakpoint pairs according to positions of the breakpoints of the lane edge line in the lane edge line, where a breakpoint pair includes a first breakpoint and a second breakpoint, and a lane edge line between the first breakpoint and the second breakpoint is blank.

In this embodiment, when the lane edge line is completed according to the breakpoints of the lane edge line, it is necessary to firstly pair the breakpoints of each lane edge line.

It can be understood that if a certain part of the lane edge line is missing, the missing part will inevitably generate two breakpoints. If these two breakpoints are connected, the lane edge line can be completed.

However, there may be multiple breakpoints in the lane edge line, so in order to determine which two breakpoints should be connected, it is necessary to pair the multiple breakpoints of the lane edge line to obtain multiple breakpoint pairs.

In a possible implementation of this embodiment, matching may be performed on multiple breakpoints of the lane edge line according to the position of each breakpoint of the lane edge line in the lane edge line, thereby obtaining multiple breakpoint pairs. Each breakpoint pair includes a first breakpoint and a second breakpoint. It can be understood that the first breakpoint and the second breakpoint are both the breakpoints of the lane edge line, and a lane edge line between the first breakpoint and the second breakpoint is blank. That is to say, there is no lane edge line between the first breakpoint and the second breakpoint.

For example, it can be understood with reference to FIG. 5. As shown in FIG. 5, the lane edge line on the left side of the road is discontinuous, and breakpoint extraction is performed on the lane edge line on the left side. It is assumed that 6 breakpoints can be extracted as shown in FIG. 5, namely a breakpoint 501, a breakpoint 502, a breakpoint 503, a breakpoint 504, a breakpoint 505 and a breakpoint 506.

Currently, matching is performed on these 6 breakpoints to determine multiple breakpoint pairs. In a possible implementation, when matching breakpoints, two adjacent breakpoints are acquired each time, for example along the direction of the lane edge line, and if it is determined that there is no lane edge line between the two breakpoints, the two breakpoints are determined as a breakpoint pair. After that, continue to follow the direction of the lane line to obtain the next two adjacent breakpoints, and so on, so as to match the breakpoints of the lane edge line. In another possible implementation, if it is determined that there is a lane edge line between the two breakpoints acquired currently, select one breakpoint arbitrarily from the two breakpoints, acquire a breakpoint adjacent to the breakpoint selected arbitrarily to obtain a new adjacent breakpoint, and then repeat the above operation.

For example, in the example of FIG. 5, two adjacent breakpoints are acquired along the direction of the lane edge line. Assuming that the breakpoint 501 and the breakpoint 502 can be acquired, it can be determined currently that there is no lane edge line between the breakpoint 501 and the breakpoint 502, that is to say, the lane edge line therebetween is blank, and then it can be determined that the breakpoint 501 and the breakpoint 502 are a breakpoint pair. After that, for example, the next two adjacent breakpoints can be acquired along the direction of the lane edge line, and the breakpoint 503 and the breakpoint 504 can be acquired. Currently, it can be determined that there is no lane edge line between the breakpoint 503 and the breakpoint 504, that is to say, the lane edge line therebetween is blank, and then it can be determined that the breakpoint 503 and the breakpoint 504 are a breakpoint pair. By that analogy, the breakpoint 505 and the breakpoint 506 can also be determined as a breakpoint pair.

For another example, in the example of FIG. 5, two adjacent breakpoints are acquired along the direction of the lane edge line. Assuming that the breakpoint 502 and the breakpoint 503 can be acquired, it can be currently determined that there is a lane edge line between the breakpoint 502 and the breakpoint 503, then one of the breakpoint 502 and the breakpoint 503 needs to be selected arbitrarily. Assuming that the breakpoint 503 is selected, then continue to acquire the breakpoint 504 adjacent to the breakpoint 503 along the direction of the lane edge line, and then the breakpoint 503 and the breakpoint 504 can be matched. Similarly as described above, the breakpoint 503 and the breakpoint 504 can be determined to be a breakpoint pair. Subsequent implementation is similar and will not be repeated here.

Based on the above description, it can be determined that the breakpoint pair includes a first breakpoint and a second breakpoint, and the first breakpoint and the second breakpoint are not limited to a specific breakpoint. For example, in the example described in FIG. 5, the breakpoint 501 and the breakpoint 502 are a breakpoint pair, and then, for example, the breakpoint 501 may be the first breakpoint, and the breakpoint 502 may be the second breakpoint. Or, it may also be the case that the breakpoint 501 is the second breakpoint, and the breakpoint 502 is the first breakpoint. This embodiment does not limit the specific implementation of the first breakpoint and the second breakpoint, as long as it can be ensured that one breakpoint of the breakpoint pair is the first breakpoint, and the other breakpoint is the second breakpoint.

And it can be understood that the current lane edge line is a general term, and all lane lines located on the side of the road are lane edge lines. In a practical implementation process, lane edge lines may exist in multiple road segments, and the above operations are performed on the lane edge lines in each road segment to determine the breakpoint pairs in all lane edge lines currently collected.

S402: for any one of the breakpoint pairs, acquire a first road segment where the first breakpoint is located, and acquire a second road segment where the second breakpoint is located.

After it is determined that multiple breakpoint pairs are obtained, it is necessary to connect each breakpoint pair correspondingly. The operation for each breakpoint pair is similar. Therefore, any breakpoint pair is taken as an example for introduction in the following. Implementations of remaining breakpoint pairs will not be described in detail.

It should be noted here that some of the current breakpoints of the lane edge line are caused by occlusion or abrasion, but there are still some breakpoints that are discontinuous in the field, such as a breakpoint on the lane edge line at an intersection, the existence of which is normal.

For example, further introduction can be made in conjunction with FIG. 6. As shown in FIG. 6, similar to the above introduction, a breakpoint 601 and a breakpoint 602 can be determined as a breakpoint pair, a breakpoint 603 and a breakpoint 604 can be determined as a breakpoint pair, and a breakpoint 607 and a breakpoint 608 can be determined as a breakpoint pair. It can be understood that the breakpoint 601, the breakpoint 602, the breakpoint 603, the breakpoint 604, the breakpoint 607 and the breakpoint 608 are all breakpoints caused by an abnormality. Under normal circumstances, these breakpoints do not exist.

However, there are also a breakpoint 605 and a breakpoint 606 in FIG. 6. The breakpoint 605 and the breakpoint 606 may be determined as a breakpoint pair, but it can be understood from FIG. 6 that the breakpoint 605 and the breakpoint 606 are not breakpoints caused by an abnormality, but breakpoints caused by a switching of road segments, that is to say, the existence of the breakpoint 605 and the breakpoint 606 is normal.

It can be understood that, for the breakpoints caused by the abnormality, it is necessary to connect the breakpoints to realize the completing of the lane line. However, for the breakpoints under normal conditions, it is not necessary to connect the breakpoints. Therefore, in this embodiment, before connecting a breakpoint pair, it is necessary to first determine whether the breakpoint pair needs to be connected.

In a possible implementation, for example, the first road segment where the first breakpoint is located may be acquired, and the second road segment where the second breakpoint is located may be acquired.

The road segment here is actually a road segment link in a road network. Road network data is collected in advance, and road segment links in the road network data includes road segments that actually exist in the road. In a possible implementation, the road segment links are divided by intersections. That is to say, a road between two intersections can be used as a road segment link, or in other words, there is no intersection in a road segment link.

For example, an implementation of road segment links can be introduced in conjunction with FIG. 7. As shown in FIG. 7, a schematic diagram of a crossroad is shown in 701. There are multiple road segments in each direction of the crossroad, namely, road segment A, road segment B, road segment C, road segment D, road segment E, road segment F, road segment G and road segment H shown in FIG. 7. Assuming that an intersection (e.g. the crossroad) is used for distinction, a road network structure shown in 702 can be obtained. The road network structure includes 8 road segment links, namely, link a, link b, link c, link d, link e, link f, link g and link h. A place where these links meet is actually the position of the intersection.

With reference to the example in FIG. 7, it can be determined that in the determination of the structure of the road segments, the road segments can usually be divided by taking an intersection as a dividing point, so as to obtain multiple road segment links. The road segment link may be in the form of a single line, and be used to briefly indicate a shape and position of a section of road.

Based on the introduction in FIG. 7, it can be determined that the road network structure can include multiple road segment links. For example, a fused image of the road can be matched with the road network structure, so as to acquire the first road segment where the first breakpoint in the breakpoint pair is located, and the second road segment where the second breakpoint in the breakpoint pair is located.

S403: if the first road segment and the second road segment are a same road segment, determine a road segment type of a target road sub-segment, where the target road sub-segment is a sub-road segment between the first breakpoint and the second breakpoint on the first road segment, and the road segment type includes at least one of the following: a straight road segment, a curved road segment.

After acquiring the first road segment where the first breakpoint is located and the second road segment where the second breakpoint is located, for example, it can be first determined whether the first road segment and the second road segment are the same road segment.

In a possible implementation, if it is determined that the first road segment and the second road segment are not the same road segment, it can be determined that the first breakpoint and the second breakpoint in the current breakpoint pair belong to different road segments, and thus the road segments corresponding to these two breakpoints are not continuous. That is to say, the lane edge line in the field road corresponding to the two breakpoints is discontinuous, so the identification of the breakpoints included in the current breakpoint pair is normal. In this case, there is no need to perform connecting processing on this breakpoint pair, and just move on and process the next breakpoint pair.

In another possible implementation, if it is determined that the first road segment and the second road segment are the same road segment, it can be determined that the first breakpoint and the second breakpoint in the current breakpoint pair belong to the same road segment, and thus the road segments corresponding to these two breakpoints are continuous. That is to say, the lane edge line in the field road corresponding to the two breakpoints is continuous, so the breakpoints included in the current breakpoint pair are actually breakpoints that should not exist. In this case, it can be determined that the lane edge line corresponding to the first breakpoint and the second breakpoint in the current breakpoint pair is incomplete.

It is necessary to connect the first breakpoint and the second breakpoint in the current breakpoint pair. Further, in order to ensure the correctness of the direction of the breakpoint connection, for example, it can be first determined whether the first breakpoint and the second breakpoint should be connected to be a straight line or a curved line.

In a possible implementation, for example, on the first road segment, a road sub-segment between the first breakpoint and the second breakpoint in the breakpoint pair which is processed currently may be determined as a target road sub-segment. Then, the road segment type of the target road sub-segment is acquired, where the road segment type may include at least one of the following: a straight road segment and a curved road segment.

It should be noted here that, if it is determined that the breakpoints in the current breakpoint pair needs to be connected, it means that the first road segment corresponding to the first breakpoint and the second road segment corresponding to the second breakpoint have been determined to be the same road segment. In this case, it can be said that the target road sub-segment is determined on the first road segment, or it can also be said that the target road sub-segment is determined on the second road segment, both of which indicate the same meaning, because the first road segment and the second road segment are the same road segment.

The target road sub-segment can be understood, for example, in conjunction with FIG. 8. As shown in FIG. 8, it is assumed that there is a first road segment (also a second road segment) currently, and there is a first breakpoint 801 and a second breakpoint 802 in the first road segment. Then a road sub-segment between the first breakpoint 801 and the second breakpoint 802 on the first road segment can be determined as the target road sub-segment shown in FIG. 8. This is the target sub-segment determined for the breakpoint pair including the breakpoint 801 and the breakpoint 802. For the breakpoint pair including a breakpoint 803 and a breakpoint 804 in FIG. 8, an implementation of determining the target sub-segment is also similar, which will not be repeated here.

When the road segment type of the first road segment is acquired, in a possible implementation, for example, a corresponding starting point (x1, y1) and end point (x2, y2) on the target road sub-segment can be obtained (the interval length of the target road sub-segment is ab), and then the starting point and the end point can be connected into a line segment cd, where the length of cd is:

cd=\sqrt{(x₁−x₂)²+(y₁−y₂)²}.

Then the length of ab can be compared with the length of cd. If ab>cd, it can be determined that the road segment type of the current target road sub-segment is a curved segment; if ab=cd, it can be determined that the road segment type of the current target road sub-segment is a straight road segment.

Or, the road segment type can also be determined by comparing slopes of the points. For example, any two points (x1, y1) and (x2, y2) can be taken on the target road sub-segment to calculate a slope k, where a calculation method for the slope k can be:

$$k = \frac{( {x}_{1} - {x}_{2} )}{( {y}_{1} - {y}_{2} )} .$$

When it is determined that slopes k of any two arbitrary points on the target road sub-segment are the same, it can be determined that the road segment type of the current target road sub-segment is a straight road segment. Or, when it is determined that the slopes k of the two arbitrary points are different, it can be determined that the road segment type of the current target road sub-segment is a curved road segment.

It should also be noted that, FIG. 8 illustrates the case where the entire first road segment is a straight line. In fact, an implementation of a polyline part in the first road segment is similar, which can be understood with reference to FIG. 9.

As shown in FIG. 9, it is assumed that there is a first road segment (also a second road segment) currently, and there is a first breakpoint 901 and a second breakpoint 902 in the first road segment. Then a road sub-segment between the first breakpoint 901 and the second breakpoint 902 on the first road segment can be determined as the target road sub-segment shown in FIG. 9. This is the target sub-segment determined for the breakpoint pair including the breakpoint 901 and the breakpoint 902. For the breakpoint pair including a breakpoint 903 and a breakpoint 904 in FIG. 9, an implementation of determining the target sub-segment is also similar, which will not be repeated here.

And for the target road sub-segment shown in FIG. 9, an implementation of determining the road segment type is similar to that described above, which will not be repeated here. It can be understood that, in the example of FIG. 9, although the first road segment is in a form of a polyline, the target road sub-segment is still a straight line.

S404: if the road segment type is the straight road segment, connect the first breakpoint and the second breakpoint to complete the lane edge line to obtain a continuous lane edge line.

In a possible implementation, if it is determined that the road segment type of the target sub-segment is the straight road segment, then, for example, the first breakpoint and the second breakpoint may be directly connected to complete the lane edge line, thereby obtaining a continuous lane edge line.

For example, it can be understood with reference to FIG. 8 that, for the target road sub-segment between the breakpoint 801 and the breakpoint 802 in FIG. 8, a connection can be made directly using a straight line, so as to realize completing of the lane edge line. And for the target road sub-segment between the breakpoint 803 and the breakpoint 804 in FIG. 8, a connection can also be made directly using a straight line, so as to realize completing of the lane edge line.

As another example, for the example in FIG. 9, for the target road sub-segment between the breakpoint 901 and the breakpoint 902 in FIG. 9, a connection can be made directly using a straight line, so as to realize completing of the lane edge line. And for the target road sub-segment between the breakpoint 903 and the breakpoint 904 in FIG. 9, a connection can also be made directly using a straight line, so as to realize completing of the lane edge line.

S405: if the road segment type is the curved road segment, acquire a first road width corresponding to the first breakpoint, and acquiring a second road width corresponding to the second breakpoint.

In another possible implementation, if it is determined that the road segment type of the target road sub-segment is the curved road segment, the first breakpoint and the second breakpoint cannot be directly connected in a straight line. Further, for example, different connecting strategies may be adopted according to a change characteristic of road width corresponding to the first breakpoint and the second breakpoint.

For example, the first road width corresponding to the first breakpoint can be acquired, where the first road width represents a road lateral width for a position where the first breakpoint is located, and the second road width corresponding to the second breakpoint can be acquired, where the second road width represents a road lateral width for a position where the second breakpoint is located.

S406: determine at least one shape reference point according to the first road width and the second road width.

It can be understood that, for the current breakpoint pair of which the target road sub-segment is of a curved type, curve fitting needs to be performed when realizing the connection. In order to ensure the correctness of the curve fitting, at least one shape reference point can be determined. The shape reference point is a point used to control the curve shape in the curve fitting.

For example, after the first road width corresponding to the first breakpoint and the second road width corresponding to the second breakpoint are determined, at least one shape reference point can be determined according to the first road width and the second road width.

For example, a difference between the first road width and the second road width can be determined, and then the difference is compared with a preset threshold to determine whether there is a large change between the road width at the first breakpoint and the road width at the second breakpoint.

In a possible implementation, if it is determined that the difference between the first road width and the second road width is greater than or equal to the preset threshold, for example, a first quantity of shape reference points may be collected on the part of the lane edge line where the first breakpoint is located, and for example, a second quantity of shape reference points may be collected on the part of the lane edge line where the second breakpoint is located, so as to obtain multiple shape reference points.

For example, it can be understood in conjunction with FIG. 10. As shown in FIG. 10, it is assumed that current breakpoint 1001 and breakpoint 1002 form a breakpoint pair. As can be seen from FIG. 10, the segment type of a target sub-segment formed by the first breakpoint 1001 and the second breakpoint 1002 is the curved road segment. Therefore, it is necessary to determine shape reference points.

At the same time, it can be seen from FIG. 10 that, there is a certain difference between the first road width corresponding to the first breakpoint 1001 and the second road width corresponding to the second breakpoint 1002. In this case, when determining the shape reference points, a first quantity of shape reference points may be collected on the part of the lane edge line where the first breakpoint is located, and a second quantity of shape reference points may be collected on the part of the lane edge line where the second breakpoint is located.

For example, referring to FIG. 10, three shape reference points are collected on the part of the lane edge line where the first breakpoint 1001 is located, namely, a shape reference point 1003, a shape reference point 1004 and a shape reference point 1005. And two shape reference points are collected on the part of the lane edge line where the second breakpoint 1002 is located, namely, a shape reference point 1006 and a shape reference point 1007. In a practical implementation process, specific settings of the first quantity and the second quantity can be selected and set according to actual needs, and specific selection positions of the shape reference points can also be selected according to actual needs. For example, a selection may be made with a fixed spacing, etc., as long as the shape reference points are on the lane edge line.

In another possible implementation, if it is determined that the difference between the first road width and the second road width is smaller than the preset threshold, an intersection point of an extension line of the part of the lane edge line where the first breakpoint is located and an extension line of the part of the lane edge line where the second breakpoint is located can be determined as a shape reference point, for example.

For example, it can be understood in conjunction with FIG. 11. As indicated by 1101 in FIG. 11, it is assumed that current breakpoint 1 and breakpoint 3 form a breakpoint pair. As can be seen from FIG. 11, the segment type of a target road sub-segment formed by the first breakpoint 1 and the second breakpoint 3 is the curved road segment. Therefore, it is necessary to determine a shape reference point.

At the same time, it can be seen from FIG. 11 that the first road width corresponding to the first breakpoint 1 and the second road width corresponding to the second breakpoint 3 are consistent, or the difference therebetween is relatively small. In view of this situation, when determining the shape reference point, referring to 1102 in FIG. 11, for example, an extension line 1104 of the part of the lane edge line where the first breakpoint 1 is located can be determined, and it is assumed that an extension line 1105 of the part of the lane edge line where the second breakpoint 3 is located can be determined. After that, referring to 1103 in FIG. 11, an intersection point 2 of the extension line 1104 and the extension line 1105 can be determined as the shape reference point corresponding to the first breakpoint 1 and the second breakpoint 3.

And for a breakpoint pair formed by a first breakpoint 4 and a second breakpoint 6 in FIG. 11, an implementation of determining a shape reference point is also similar. For example, a shape reference point 5 shown in 1103 can be determined, and the specific implementation will not be repeated here.

S407: perform curve fitting according to the first breakpoint, the second breakpoint and the shape reference point to obtain a curved segment between the first breakpoint and the second breakpoint.

After the shape reference point is determined for the breakpoint pair, curve fitting can be performed according to the first breakpoint, the second breakpoint in the breakpoint pair, and the shape reference point determined above, so as to obtain a curved segment between the first breakpoint and the second breakpoint.

In a possible implementation, there may be a certain difference between specific fitting methods when performing curve fitting for two cases, one is that the first road width and the second road width are similar, and the other that there is a significant difference between the first road width and the second road width.

For example, if the difference between the first road width and the second road width is greater than or equal to the preset threshold, it can be determined that a change between the road width corresponding to the first breakpoint and the road width corresponding to the second breakpoint is significant, for example, there is a situation such as widening or narrowing of the road. In this case, for example, a B-spline curve fitting calculation can be used to determine the curved segment between the first breakpoint and the second breakpoint through the first breakpoint, the second breakpoint and the shape reference point determined above.

For example, it can be understood with reference to FIG. 10. For example, curve fitting can be performed jointly according to the first breakpoint 1001, the second breakpoint 1002 and the shape reference points 1003, 1004, 1005, 1006 and 1007 to obtain a curved segment between the first breakpoint 1001 and the second breakpoint 1002 shown in FIG. 10.

It can be understood that, because degrees of curvature at various positions on the curved road segment with a large change between the road width corresponding to a front breakpoint to the road width corresponding to a rear breakpoint are different, curve fitting is performed by sampling multiple shape reference points on the existing lane edge line, thereby effectively ensuring that the front and rear of the curved segment obtained by curve fitting are smoothly connected, without abrupt and blunt curvature changes.

If the difference between the first road width and the second road width is smaller than the preset threshold, it can be determined that the road width corresponding to the first breakpoint and the road width corresponding to the second breakpoint are similar. In this case, for example, a Bezier curve fitting calculation can be used to determine the curved segment between the first breakpoint and the second breakpoint through the first breakpoint, the second breakpoint and the shape reference point determined above.

For example, it can be understood with reference to FIG. 11. For example, curve fitting can be performed jointly according to the first breakpoint 1, the second breakpoint 3 and the shape reference point 2, so as to obtain the curved segment between the first breakpoint 1 and the second breakpoint 3 shown by 1103 in FIG. 11. And similarly for the first breakpoint 4 and the second breakpoint 6, the curve fitting can be performed jointly according to the first breakpoint 4, the second breakpoint 6 and the shape reference point 5, so as to obtain the curved segment between the first breakpoint 4 and the second breakpoint shown by 1103 in FIG. 11.

It can be understood that, because degrees of curvature at various positions on the road segment with a front breakpoint and a rear breakpoint corresponding to similar road widths are similar, the curve fitting can be performed by directly determining a shape reference point in the middle through the extension lines, thereby effectively ensuring that the front and rear of the curved segment obtained by curve fitting are smoothly connected, so that the determination of the curved segment can be realized simply and effectively.

It should be noted that, in a practical implementation process, under different situations, the specific curve fitting algorithm used may be selected and set according to actual needs, and the specific implementation of the curve fitting algorithm is not limited in this embodiment.

S408: connect the first breakpoint and the second breakpoint according to the curved segment, to complete the lane edge line to obtain a continuous lane edge line.

After the curved segment between the first breakpoint and the second breakpoint is determined, the first breakpoint and the second breakpoint can be connected according to the determined curved segment, so as to complete the lane edge line to obtain a continuous lane edge line.

For example, referring to FIG. 10, the first breakpoint 1001 and the second breakpoint 1002 are connected by the determined curved segment, so that the discontinuous lane edge line can be completed to obtain a continuous lane edge line. And it should be noted that, when completing the lane edge line for the first breakpoint 1008 and the second breakpoint 1009 in FIG. 10, the completing is actually done according to the above-mentioned completing method for the lane edge line with the type of straight line.

For another example, referring to FIG. 11, the first breakpoint 1 and the second breakpoint 3 are connected by the determined curved segment, so that the discontinuous lane edge line can be completed to obtain a continuous lane edge line. In addition, the first breakpoint 4 and the second breakpoint 6 can be connected by the determined curved segment, so that the discontinuous lane edge line can be completed to obtain a continuous lane edge line.

In the method for processing a lane line provided in the embodiments of the present disclosure, multiple breakpoint pairs are obtained by matching multiple breakpoints of the lane edge line, so that breakpoints with discontinuity therebetween and a corresponding relationship with each other can be effectively determined. Then, for the breakpoint pair, by determining whether the first road segment corresponding to the first breakpoint and the second road segment corresponding to the second breakpoint are the same road segment, it can be determined whether the current breakpoint pair is a breakpoint pair that needs to be connected. And then only the breakpoint pair that needs to be connected is connected, so as to avoid erroneous connection of the breakpoint pair existing actually, to ensure accuracy of a generated high-definition map. Then, when connecting the breakpoint pair, the road segment type of the road sub-segment where the breakpoint pair is located will be specifically determined, and the first breakpoint and the second breakpoint will be directly connected for the straight road segment to realize the connection of the lane edge line. For the curved road, it will be further determined whether there is a large change between the road width corresponding to the first breakpoint and the road width corresponding to the second breakpoint, and then the shape reference point is determined according to different strategies. After that, the curved segment between the first breakpoint and the second breakpoint is determined according to the first breakpoint, the second breakpoint and the shape reference point, and then the first breakpoint and the second breakpoint is connected according to the curved segment to realize the connection of the lane edge line with the type of curved line. Through the method described above, completing of various types of lane edge lines can be realized, so that the lane edge lines can be completed in various scenarios flexibly and effectively, so as to effectively shorten the consumed time for generating a complete high-definition map.

Implementations of completing a lane edge line are introduced in the above embodiments. In the embodiments, a lane dividing line can also be completed based on a completed lane edge line and breakpoints of the lane dividing line, so as to fully complete the lane lines. Therefore, on the basis of the above description, implementations of completing a lane dividing line will be described in detail below with reference to FIG. 12 to FIG. 21.

FIG. 12 is a third flowchart of a method for processing a lane line provided in an embodiment of the present disclosure; FIG. 13 is a schematic diagram of a lane edge line pair provided in an embodiment of the present disclosure; FIG. 14 is a schematic diagram of a condition that first curvature information is consistent with second curvature information provided in an embodiment of the present disclosure; FIG. 15 is a schematic diagram of a condition that first curvature information is inconsistent with second curvature information provided in an embodiment of the present disclosure; FIG. 16 is a first schematic diagram of an implementation of completing a lane dividing line provided in an embodiment of the present disclosure; FIG. 17 is a second schematic diagram of an implementation of completing a lane dividing line provided in an embodiment of the present disclosure; FIG. 18 is a third schematic diagram of an implementation of completing a lane dividing line provided in an embodiment of the present disclosure; FIG. 19 is a fourth schematic diagram of an implementation of completing a lane dividing line provided in an embodiment of the present disclosure; FIG. 20 is a fifth schematic diagram of an implementation of completing a lane dividing line provided in an embodiment of the present disclosure; and FIG. 21 is a sixth schematic diagram of an implementation of completing a lane dividing line provided in an embodiment of the present disclosure.

As shown in FIG. 12, the method includes:

S1201: for any target road segment in a road, determine a lane edge line pair corresponding to the target road segment according to continuous lane edge lines, where the lane edge line pair includes continuous lane edge lines located on both sides of the target road segment.

Based on the above introduction, it can be determined that there are multiple road segments in a road, and the road segments are usually divided by intersections. At the same time, it can be determined that the lane dividing line usually exists on the road segment within the intersection, therefore in this embodiment, the road segment may be used as a unit to complete the lane dividing line. Therefore, the following description will be given by taking any target road segment in the road as an example. The implementation of completing a lane dividing line in each road segment of the road is similar, and will not be repeated below.

In a practical scenario, no matter which road segment, lane edge lines exist on both sides of the road, that is to say, there is a lane edge line on the left side of the road and a lane edge line on the right side of the road. In order to facilitate completing the lane dividing line in the target road segment, in this embodiment, a lane edge line pair corresponding to the target road segment can be determined according to the above-mentioned completed continuous lane edge lines, for example.

The lane edge line pair here includes continuous lane edge lines on both sides of the target road segment. For example, it can be understood in conjunction with FIG. 13. As shown in FIG. 13, it is assumed that there is a road segment 1, a completed continuous lane edge line 1301 on the left side of the road segment 1 and a completed continuous lane edge line 1302 on the right side of road segment 1 can be determined as a lane edge line pair. That is to say, the lane edge line pair corresponding to the road segment 1 includes the lane edge line 1301 and the lane edge line 1302.

For another example, referring to FIG. 13, there is also a road segment 2 in FIG. 13, then a completed continuous lane edge line 1303 on the left side of the road segment 2 and a completed continuous lane edge line 1304 on the right side of road segment 2 can be determined as a lane edge line pair. That is to say, the lane edge line pair corresponding to the road segment 2 includes the lane edge line 1303 and the lane edge line 1304.

S1202: acquire first curvature information of the target road segment, and acquire second curvature information of the lane edge line pair corresponding to the target road segment.

In this embodiment, when completing the lane dividing line, processing methods are different for two cases, one is that the curvature of the lane dividing line and the curvature of the target road segment are consistent, and the other is that the curvature of the lane dividing line and the target road segment are inconsistent.

In this embodiment, the first curvature information of the target road segment can be acquired, and the first curvature information may include the curvature of points in the target road segment. And in this embodiment, the second curvature information of the lane edge line pair corresponding to the target road segment can also be acquired. The second curvature information can include, for example, the curvature of points on the lane edge lines of both sides in the lane edge line pair.

S1203: determine a part of the target road segment where the second curvature information is the same as the first curvature information as a first road sub-segment, and determine a part of the target road segment where the second curvature information is different from the first curvature information as a second road sub-segment, according to the first curvature information and the second curvature information.

Because the curvature of the road segment and the curvature of the lane edge lines may be consistent or inconsistent, implementations of completing a lane dividing line are different. At the same time, it can be understood that in the target road segment, there may be a part of the road segment in which the curvature of the lane edge lines is consistent with the curvature of the road segment, and there may also be another part of the road segment in which the curvature of the lane edge lines are inconsistent with the curvature of the road segment.

After acquiring the first curvature information and the second curvature information, for example, the target road segment can be divided according to the first curvature information and the second curvature information.

In a possible implementation, for example, the part of the target road segment in which the second curvature information is the same as the first curvature information may be determined as a first road sub-segment. In other words, the first road sub-segment is the part of the target road segment where the curvature of the lane edge lines in the target road segment is consistent with the curvature of the target road segment.

For example, as can be understood with reference to FIG. 14, it is assumed that 1403 in FIG. 14 represents a target road segment, and a lane edge line 1401 and a lane edge line 1402 represent a lane edge line pair of the target road segment 1403. It can be determined with reference to FIG. 14 that the curvature of the current road segment 1403 is consistent with the curvature of various positions of the lane edge line 1401 and the lane edge line 1402, and then the current target road segment 1403 can be determined as a first road sub-segment.

Similarly, it is assumed that 1406 in FIG. 14 represents a target road segment, and a lane edge line 1404 and a lane edge line 1405 represent a lane edge line pair of the target road segment 1406. It can be determined with reference to FIG. 14 that the curvature of the current road segment 1406 is consistent with the curvature of various positions of the lane edge line 1404 and the lane edge line 1405, and then the current target road segment 1406 can be determined as a first road sub-segment.

The part of the target road segment in which the second curvature information is different from the first curvature information may be determined as a second road sub-segment. In other words, the second road sub-segment is the part of the target road segment where the curvature of the lane edge lines in the target road segment is inconsistent with the curvature of the target road segment.

For example, as can be understood with reference to FIG. 15, it is assumed that 1503 in FIG. 15 represents a target road segment, and a lane edge line 1501 and a lane edge line 1502 represent a lane edge line pair of the target road segment 1503. It can be determined with reference to FIG. 15 that, in a part of the road segment indicated by the second road sub-segment, the curvature of the current road segment 1503 is inconsistent with the curvature of various positions of the lane edge line 1501 and the lane edge line 1502, and then the second road sub-segment shown in FIG. 15 can be determined. Two first road sub-segments shown in FIG. 15 can also be determined, and the implementation of the first road sub-segment is similar to that described above.

Based on the above description, it can be understood that there may be a situation where all road sub-segments included in a certain target road segment are the first road sub-segments, and there is no second road sub-segment. There also may be a situation that all road sub-segments included in a certain target road segment are the second sub-segments, and there is no first road sub-segment.

S1204: for the first road sub-segment, if there is no lane dividing line between the lane edge line pair, acquire a road width between the lane edge line pair, and acquire a lane width corresponding to the target road segment.

In this embodiment, a processing method for the first road sub-segment is different from a processing method for the second road sub-segment. The processing for the first road sub-segment will be introduced first. In this embodiment, there are two cases for the processing of the first road sub-segment. One case is that there is a lane dividing line between the lane edge line pair, but the lane dividing line is discontinuous; and the other case is that there is no lane dividing line between the lane edge line pair at all, that is, the lane dividing line is blank. Therefore, it can be determined whether there is a lane dividing line between the lane edge line pair.

In a possible implementation, if it is determined that there is no lane dividing line between the lane edge line pair, for example, a road width between the lane edge line pair and a lane width corresponding to the first road sub-segment can be acquired. For example, the lane width of each part is stored in a preset storage space, and the lane width can be acquired directly from the preset storage space.

S1205: when it is determined that the first road sub-segment includes at least two lanes, determine a quantity t of lane dividing lines according to the road width and the lane width, where t is an integer greater than or equal to 1.

After the road width and the lane width are determined, for example, it may be first determined whether two lanes are included in the first road sub-segment according to the road width and the lane width.

For example, it can be determined whether the road width is less than twice the lane width. If it is determined that the road width is less than twice the lane width, it can be determined that only one lane is currently included in the first road sub-segment, then it is correct that the current lane dividing line in the first road sub-segment is blank, and there is no need to process a lane dividing line for the current first road sub-segment.

Or, if it is determined that the road width is greater than or equal to twice the lane width, it can be determined that the first road sub-segment currently includes at least two lanes, then it is incorrect that the current lane dividing line in the first road sub-segment is blank. Therefore, it is necessary to process a lane dividing line for the current first road sub-segment.

When it is determined that the first road sub-segment includes at least two lanes, for example, the quantity t of the lane dividing lines may be determined according to the road width and the lane width. The determination oft can, for example, satisfy: (road width/lane width)=t.

S1206: insert t lane dividing lines between the lane edge line pair at equal distance, where the t lane dividing lines are parallel to the lane edge line pair.

After the quantity t of lane dividing lines is determined, the t lane dividing lines can be inserted between the lane edge line pair at equal distance, and the t lane dividing lines inserted currently are parallel with the lane edge line pair. That is to say, the t lane dividing lines can be inserted in parallel between the lane edge line pair at equal distance according to the direction or curvature of the lane edge lines. The insertion at equal distance here actually means that the inserted t lane dividing lines can equally divide the road between the lane edge line pair into t+1 lanes.

For example, this can be understood in conjunction with FIG. 16. As shown in FIG. 16, it is assumed that the lane edge line pair of the current first road sub-segment includes a lane edge line 1601 and a lane edge line 1602 in FIG. 16, and that the current quantity of lanes is 2, then the quantity t of lane dividing lines can be determined to be 1 correspondingly. That is to say, one lane line needs to be inserted between the lane edge line 1601 and the lane edge line 1602 at equal distance, that is, 1603 in FIG. 16. The lane dividing line 1603 realizes that the road between the lane edge line 1601 and the lane edge line 1602 is equally divided into two lanes, and the lane dividing line 1603 is parallel with both of the lane edge line 1601 and the lane edge line 1602.

S1207: for the first road sub-segment, if there is a lane dividing line between the lane edge line pair, extend, according to the second curvature information of the lane edge line pair, the lane dividing line from breakpoints of the lane dividing line until extension lines of two breakpoints of the lane dividing line are connected to each other, or until extension lines of the breakpoints of the lane dividing line are flush with an edge of the lane edge line corresponding to the first road sub-segment.

In another possible implementation, if it is determined that there is a lane dividing line between the lane edge line pair, but the existing lane dividing line is discontinuous, the existing lane dividing line can be completed.

For example, the lane dividing line can be extended from breakpoints of the lane dividing line according to the second curvature information of the lane edge line pair, that is to say, the lane dividing line can be extended from the breakpoints of the lane dividing line according to the curvature of various points on the lane edge lines. The extension continues until the extension lines of two breakpoints of the lane dividing line are connected to each other, or until the extension lines of the breakpoints of the lane dividing line are flush with an edge of the lane edge line corresponding to the first road sub-segment. It should be noted that the lane edge lines corresponding to the first road sub-segment here refer to a part of the lane edge lines located on both sides of the first road sub-segment.

For example, this can be understood with reference to FIG. 17. Referring to FIG. 17, for example, the extension can be performed from a breakpoint 1701, a breakpoint 1702 and a breakpoint 1703 of lane dividing lines along the curvature of the lane dividing lines. Referring to FIG. 17, it can be determined that an extension line of the breakpoint 1701 and an extension line of the breakpoint 1702 will be connected to each other, so as to realize the completing of the lane dividing line of the left lane, and that an extension line of the breakpoint 1703 will be flush with the edge of the lane edge line corresponding to the first road sub-segment. Thereby, the completing of the lane dividing line of the right lane is realized.

S1208: for the second road sub-segment, acquire n first lane dividing lines with breakpoints located in the front of the second road sub-segment, and acquire m second lane dividing lines with breakpoints located in the rear of the second road sub-segment, according to the travelling direction of the road, where n and m are integers greater than or equal to 1.

The method for completing the lane dividing line of the first road sub-segment has been described above. In this embodiment, another completing method will be adopted for the second road sub-segment.

Specifically, for the second road sub-segment, n first lane dividing lines with breakpoints located in the front of the second sub-segment along the travelling direction are acquired, and m second lane dividing lines with breakpoints in the rear of the second sub-segment along the travelling direction are acquired, according to the travelling direction corresponding to the current road.

For example, this can be understood in conjunction with FIG. 18. Referring to part A in FIG. 18, it is assumed that the target road segment is currently divided into two first road sub-segments and one second road sub-segment. For the specific implementation of division into the first road sub-segment and the second road sub-segment, the introduction described above can be referred to, and will not be repeated here.

Referring to part B in FIG. 18 further, discontinuous parts in the first road sub-segments can be completed according to the implementations described above, so that the lane dividing lines in each first road sub-segment are completed to an edge part of the lane edge line corresponding to the first road sub-segment, which is the state shown in part B in FIG. 18.

After that, the second road sub-segment can be completed. As shown in part C in FIG. 18, the travelling direction of the road can be illustrated, for example, by the arrow at the far right in FIG. 18, where 1801 indicates the front, and 1802 indicates the rear. That is to say, the travelling direction along the road is a direction from the front to the rear.

Then, two first lane dividing lines with breakpoints in the front of the second road sub-segment can be determined, namely, a lane dividing line N4 and a lane dividing line N5 shown in part C of FIG. 18. Three second lane dividing lines with breakpoints located in the rear of the second road sub-segment can be determined, namely, a lane dividing line N1, a lane dividing line N2 and a lane dividing line N3 shown in part C of FIG. 18.

It needs to be emphasized here that, what are currently determined is the lane dividing lines with breakpoints in the front and in the rear. It is assumed that in part C of FIG. 18, the lane dividing line N4 and the lane dividing line N1 are kept connected without discontinuity, then it can be determined that the first quantity n of the first lane dividing lines is 1 (including N5), and it can be determined that the second quantity m of the second lane dividing lines is 2 (including N2 and N3).

S1209: determine corresponding relationships between then first lane dividing lines and the m second lane dividing lines.

After that, the corresponding relationships between the n first lane dividing lines and the m second lane dividing lines can be determined.

In a possible implementation, if the first quantity n is less than the second quantity m, the m second lane dividing lines are divided sequentially into n groups according to a direction from outside of the road to inside of the road, where there is a corresponding relationship between the a-th group of the second lane dividing lines and the a-th one of the first lane dividing lines, and a value of a includes 1 to n.

In the first n-1 groups of then groups of second lane dividing lines, a quantity of the second lane dividing lines is x, and in the n-th group of the n groups of second lane dividing lines, a quantity of the second lane dividing lines is y, where x is a value obtained by rounding up a ratio of m to n, and y is a value obtained by rounding down a ratio of m to n.

For example, this can be understood with reference to FIG. 18. As shown in part C of FIG. 18, the current 2 first lane dividing lines are the lane dividing line N4 and the lane dividing line N5, and the three second lane dividing lines are the lane dividing line N1, the lane dividing line N2, and the lane dividing line N3.

That is, n equals to 2 and m equals to 3. At this time, it can be determined that the first quantity n is less than the second quantity m, and then the 3 second lane dividing lines from right to left can be divided into 2 groups according to the direction from outside of the road to inside of the road (that is, from the right to the left corresponding to FIG. 18). Among the 2 groups of second lane dividing lines, the quantity of second lane dividing lines in the former group is

$$⌈ \frac{3}{2} ⌉ = 2 ,$$

and the quantity of second lane dividing lines in the latter group is

$$⌊ \frac{3}{2} ⌋ = 1.$$

Then, it can be determined that the second lane dividing lines in the former group include: N3 and N2, and it can be determined that the second lane dividing line in the latter group includes N1.

In this embodiment, it can be determined that the 2 groups of second lane dividing lines have corresponding relationships with the 2 first lane dividing lines in sequence. In fact, that is to say, there is a corresponding relationship between the first group of the second lane dividing lines and the first one of the first lane dividing lines. That is to say, when corresponding to the example in FIG. 18, there is a corresponding relationship between the second lane dividing lines N3 and N2 in the former group and the first lane dividing line N5.

There is a corresponding relationship between the second group of the second lane dividing lines and the second one of the first lane dividing lines. That is to say, when corresponding to the example in FIG. 18, there is a corresponding relationship between the second lane dividing line N1 in the latter group and the first lane dividing line N4.

It can be understood that the above description is for the case where n is equal to 2 and m is equal to 3. For another example, n can be equal to 3, and m can be equal to 5.

The case of n=3, m=5 is that there are 3 first lane dividing lines and 5 second lane dividing lines. It can be understood in conjunction with FIG. 19 that, the 3 first lane dividing lines in FIG. 19 are a lane dividing line N1, a lane dividing line N2 and a lane dividing line N3, and the 5 second lane dividing lines in FIG. 19 are a lane dividing line N4, a lane dividing line N5, a lane dividing line N6, a lane dividing line N7 and a lane dividing line N8.

At this time, it can be determined that the first quantity n is less than the second quantity m, and then the 5 second lane dividing lines from right to left can be divided into 3 groups according to the direction from outside of the road to inside of the road (that is, from the right to the left corresponding to FIG. 19). Among the 3 groups of second lane dividing lines, the quantity of second lane dividing lines in the former two groups is

$$⌈ \frac{5}{3} ⌉ = 2 ,$$

and the quantity of second lane dividing lines in the latter group is

$$⌊ \frac{5}{3} ⌋ = 1.$$

Then it can be determined that the second lane dividing lines in the first group include: N7 and N8, the second lane dividing lines in the second group include: N5 and N6, and the second lane dividing line in the third group includes: N4.

In this embodiment, it can be determined that the 3 groups of second lane dividing lines have corresponding relationships with the 3 first lane dividing lines in sequence. In fact, that is to say, there is a corresponding relationship between the first group of second lane dividing lines and the first one of the first lane dividing lines. That is to say, when corresponding to the example in FIG. 19, there is a corresponding relationship between the second lane dividing lines N7 and N8 in the first group and the first lane dividing line N3.

There is a corresponding relationship between the second group of second lane dividing lines and the second one of the first lane dividing lines. That is to say, when corresponding to the example in FIG. 19, there is a corresponding relationship between the second lane dividing lines N5 and N6 in the second group and the first lane dividing line N2.

There is a corresponding relationship between the third group of second lane dividing lines and the third one of the first lane dividing lines. That is to say, when corresponding to the example in FIG. 19, there is a corresponding relationship between the second lane dividing line N4 in the third group and the first lane dividing line N1.

Implementations for remaining values of m and n are similar, and will not be repeated here.

In another possible implementation, if the first quantity n is greater than or equal to the second quantity m, the n first lane dividing lines are divided sequentially into m groups according to a direction from inside of the road to outside of the road, where there is a corresponding relationship between the b-th group of the second lane dividing lines and the b-th one of the first lane dividing lines, and a value of b includes 1 to m.

In the first m-1 groups of the m groups of first lane dividing lines, a quantity of the first lane dividing lines is p, and in the m-th group of the m groups of first lane dividing lines, a quantity of the first lane dividing lines is q, where p is a value obtained by rounding up a ratio of n to m, and q is a value obtained by rounding down a ratio of n to m.

FIG. 20 is similar to FIG. 18 above. A target road segment is also divided into 2 first road sub-segments and 1 second road sub-segment, and part A in FIG. 20 and part B in FIG. 20 also illustrate the completing for the first road sub-segment part. For the specific implementation thereof, the above introduction can be referred to, and will not be repeated here.

Similarly, the travelling direction of the road can be illustrated, for example, by the arrow at the far right in FIG. 20, where 2001 indicates the front, and 2002 indicates the rear. That is to say, the travelling direction along the road is a direction from the front to the rear.

Referring to part C shown in FIG. 20, 3 first lane dividing lines with breakpoints located in the front of the second road sub-segment can be determined, namely, a lane dividing line N1, a lane dividing line N2 and a lane dividing line N3 shown in part C of FIGS. 20. And 2 second lane dividing lines with breakpoints located in the rear of the second road sub-segment can be determined, namely, a lane dividing line N4 and a lane dividing line N5 shown in part C of FIG. 20.

That is, n equals to 3 and m equals to 2. At this time, it can be determined that the first quantity n is greater than the second quantity m, and then the 3 first lane dividing lines from the left to right can be divided into 2 groups according to the direction from inside of the road to outside of the road (that is, from the left to the right corresponding to FIG. 20). Among the 2 groups of first lane dividing lines, the quantity of first lane dividing lines in the former group is

$$⌈ \frac{3}{2} ⌉ = 2 ,$$

and the quantity of the first lane dividing lines in the latter group is

$$⌊ \frac{3}{2} ⌋ = 1.$$

Then, it can be determined that the first lane dividing lines in the former group include: N1 and N2, and it can be determined that the first lane dividing line in the latter group includes N3.

In this embodiment, it can be determined that the 2 groups of first lane dividing lines have corresponding relationships with the 2 second lane dividing lines in sequence. In fact, that is to say, there is a corresponding relationship between the first group of the first lane dividing lines and the first one of the second lane dividing lines. That is to say, when corresponding to the example in FIG. 20, there is a corresponding relationship between the first lane dividing lines N1 and N2 in the former group and the second lane dividing line N4.

There is a corresponding relationship between the second group of the first lane dividing lines and the second one of the second lane dividing lines. That is to say, when corresponding to the example in FIG. 20, there is a corresponding relationship between the first lane dividing line N3 in the latter group and the second lane dividing line N5.

It can be understood that the above description is for the case where n is equal to 3 and m is equal to 2. For another example, n can be equal to 4, and m can be equal to 2.

The case of n=4, m=2 is that there are 4 first lane dividing lines and 2 second lane dividing lines. It can be understood in conjunction with FIG. 21 that, the 4 first lane dividing lines in FIG. 21 are a lane dividing line N1, a lane dividing line N2, a lane dividing line N3 and a lane dividing line N4, and the 2 second lane dividing lines in FIG. 21 are a lane dividing line N5 and a lane dividing line N6.

At this time, it can be determined that the first quantity n is greater than the second quantity m, and then the 4 first lane dividing lines from left to right can be divided into 2 groups according to the direction from inside of the road to outside of the road (that is, from the left to the right corresponding to FIG. 19). Among the 2 groups of first lane dividing lines, the quantity of first lane dividing lines in the former group is

$$⌈ \frac{4}{2} ⌉ = 2 ,$$

and the quantity of first lane dividing lines in the latter group is

$$⌊ \frac{4}{2} ⌋ = 2.$$

Then, it can be determined that the first lane dividing lines in the former group include: N1 and N2, and it can be determined that the first lane dividing lines in the latter group include N3 and N4.

In this embodiment, it can be determined that the 2 groups of first lane dividing lines have corresponding relationships with the 2 second lane dividing lines in sequence. In fact, that is to say, there is a corresponding relationship between the first group of the first lane dividing lines and the first one of the second lane dividing lines. That is to say, when corresponding to the example in FIG. 21, there is a corresponding relationship between the first lane dividing lines N1 and N2 in the former group and the second lane dividing line N5.

There is a corresponding relationship between the second group of the first lane dividing lines and the second one of the second lane dividing lines. That is to say, when corresponding to the example in FIG. 21, there is a corresponding relationship between the first lane dividing lines N3 and N4 in the latter group and the second lane dividing line N6.

Implementations for remaining values of m and n are similar, and will not be repeated here.

S1210: connect a first lane dividing line and a second lane dividing line that have a corresponding relationship from breakpoints, to complete the lane dividing line to obtain a continuous lane dividing line.

After the corresponding relationships between the first lane dividing lines and the second lane dividing lines are determined, the first lane dividing line and the second lane dividing line that have a corresponding relationship can be connected from the breakpoints. For example, this can be understood with reference with the above FIG. 18 to FIG. 21, so as to realize the completing of the lane dividing line to obtain a continuous lane dividing line.

In the method for processing a lane line provided in the embodiments of the present disclosure, a road segment is taken as a unit. For any target road segment, by acquiring the curvature of the target road segment and the curvature of the lane edge lines corresponding to the target road segment and then comparing whether the two curvature are the same, determining the part of the target road segment where the curvature of the road segment is the same as the curvature of the lane edge lines as the first road sub-segment, and determining the part of the target road segment where the curvature of the road segment is different from the curvature of the lane edge lines as the second road sub-segment, different types of parts in the target road segment can be divided, and then dealt with in a targeted manner to ensure the correctness and rationality of completing of the lane dividing lines.

For the first road sub-segment, the cases where there is a lane dividing line and where there is no lane dividing line in the road are further subdivided. For the case where there is no lane dividing line, the quantity of the lane dividing lines is determined through the road width and the lane width, and then the corresponding quantity of lane dividing lines are inserted into the road at equal distance, so that completing of the lane dividing lines for the road without a lane dividing line can be effectively realized. At the same time, before completing the lane dividing lines, it will be first determined whether there are multiple lanes in the current road, so as to avoid wrong insertion of the lane dividing line for a single-lane road, thereby ensuring the correctness of the inserted lane dividing line. For the case where there is a lane dividing line, the lane dividing line is extended from a breakpoint along the lane edge line until extending to the extension line of another breakpoint, or until extending to the edge of the road segment, so as to effectively realize the completing of the actual lane dividing line, and that the extension is carried out along the direction of the lane edge line, thereby ensuring the correctness of the completed lane dividing line.

For the second road sub-segment, that is, the part of the road segment in which the curvature of the road segment is different from the curvature of the lane edge lines, by acquiring the first lane dividing lines with breakpoints in the front and the second lane dividing lines with breakpoints in the rear, determining the corresponding relationships between the first lane dividing lines and the second lane dividing lines according to the implementations described above, and completing the lane dividing lines according to the corresponding relationships, connection of the discontinuous lane dividing lines can be effectively realized. And based on the above introduction, it can be determined that when determining the corresponding relationships between the first lane dividing lines and the second lane dividing lines, in a practical scenario, it is actually to determine how the respective lane dividing lines are connected when the quantity of lane dividing lines changes. In the embodiments, the corresponding relationships are determined according to a principle of equal division in a preset direction, so that the correctness of the determined connection mode of the lane dividing lines can be ensured as much as possible.

Based on the above introduction, it can be understood that the technical solutions provided in the present disclosure can effectively realize the completing of discontinuous lane dividing lines without re-collecting data.

In a possible implementation of this embodiment, when completing a lane line, the completed part of the lane line may be displayed in a preset style in the fused image, for example.

For example, a completed part of a lane dividing line may be displayed in a first preset style, and a completed part of a lane edge line may be displayed in a second preset style.

The first preset style and the second preset style can be selected according to actual needs. For example, a dotted line, a thick line, a line with a fixed color and the like can be used.

By displaying the completed part of the lane line in the preset style, an operator or a user can determine that the current part of the lane line has been performed completing processing on, that is, it is not collected on the spot. By identifying the completed part of the lane line using the preset style, it can be effectively distinguished from the normally collected lane line, so that the relevant personnel can quickly confirm such information. The correctness and effectiveness of information displayed in the high-definition map can be ensured.

To sum up, the technical solutions of the present disclosure provide a processing method for automatically processing a lane edge line and a lane dividing line, which can effectively solve the problem of incompleteness of the identified lane edge line and lane dividing line caused by vehicle occlusion, field marking line abrasion, etc., thereby reducing the cost of collection and production, shortening data production cycle, and ensuring the application effect of the high-definition map.

FIG. 22 is a schematic structural diagram of an apparatus for processing a lane line provided in an embodiment of the disclosure. As shown in FIG. 22, the apparatus 220 for processing a lane line in this embodiment can include: a processing module 2201, an acquiring module 2202, a first completing module 2203 and a second completing module 2204.

The processing module 2201 is configured to obtain a lane edge line of a road and a lane dividing line of the road according to point cloud data and image information of the road;

the acquiring module 2202 is configured to acquire breakpoints of the lane edge line, and acquire breakpoints of the lane dividing line;

the first completing module 2203 is configured to complete the lane edge line according to the breakpoints of the lane edge line, to obtain a continuous lane edge line;

the second completing module 2204 is configured to complete the lane dividing line according to the breakpoints of the lane dividing line and the continuous lane edge line, to obtain a continuous lane dividing line.

In a possible implementation, the first completing module 2203 is specifically configured to:

match the breakpoints of the lane edge line into multiple breakpoint pairs according to positions of the breakpoints of the lane edge line in the lane edge line, where a breakpoint pair includes a first breakpoint and a second breakpoint, and a lane edge line between the first breakpoint and the second breakpoint is blank;

for any one of the breakpoint pairs, acquire a first road segment where the first breakpoint is located, and acquire a second road segment where the second breakpoint is located;

if the first road segment and the second road segment are a same road segment, complete the lane edge line according to the first road segment and the second road segment to obtain a continuous lane edge line.

In a possible implementation, the first completing module 2203 is specifically configured to:

determine a road segment type of a target road sub-segment, where the target road sub-segment is a road sub-segment between the first breakpoint and the second breakpoint in the first road segment, and the road segment type includes at least one of the following: a straight road segment, a curved road segment;

if the road segment type is the straight road segment, connect the first breakpoint and the second breakpoint to complete the lane edge line to obtain a continuous lane edge line; or,

if the road segment type is the curved road segment, perform curve fitting according to the first breakpoint and the second breakpoint to obtain a curved segment between the first breakpoint and the second breakpoint; connect the first breakpoint and the second breakpoint according to the curved segment, to complete the lane edge line to obtain a continuous lane edge line.

In a possible implementation, the first completing module 2203 is specifically configured to:

acquire a first road width corresponding to the first breakpoint, and acquire a second road width corresponding to the second breakpoint;

determine at least one shape reference point according to the first road width and the second road width;

perform curve fitting according to the first breakpoint, the second breakpoint and the shape reference point to obtain a curved segment between the first breakpoint and the second breakpoint.

In a possible implementation, the first completing module 2203 is specifically configured to:

if a difference between the first road width and the second road width is smaller than a preset threshold, determine an intersection point of an extension line of a part of the lane edge line where the first breakpoint is located and an extension line of a part of the lane edge line where the second breakpoint is located as the shape reference point;

if the difference between the first road width and the second road width is greater than or equal to the preset threshold, collect a first quantity of shape reference points on the part of the lane edge line where the first breakpoint is located, and collect a second quantity of shape reference points on the part of the lane edge line where the second breakpoint is located.

In a possible implementation, the second completing module 2204 is specifically configured to:

for any target road segment in the road, determine a lane edge line pair corresponding to the target road segment according to the continuous lane edge line, where the lane edge line pair includes continuous lane edge lines located on both sides of the target road segment;

acquire first curvature information of the target road segment, and acquire second curvature information of the lane edge line pair corresponding to the target road segment;

complete the lane dividing line according to the first curvature information, the second curvature information and the breakpoints of the lane dividing line, to obtain a continuous lane dividing line.

In a possible implementation, the second completing module 2204 is specifically configured to:

determine a part of the target road segment where the second curvature information is the same as the first curvature information as a first road sub-segment, and determine a part of the target road segment where the second curvature information is different from the first curvature information as a second road sub-segment, according to the first curvature information and the second curvature information;

for the first road sub-segment, complete the lane dividing line according to the lane edge line pair and the breakpoints of the lane dividing line, to obtain a continuous lane dividing line;

for the second road sub-segment, complete the lane dividing line according to a travelling direction of the road and the breakpoints of the lane dividing line, to obtain a continuous lane dividing line.

In a possible implementation, if there is no lane dividing line between the lane edge line pair, the second completing module 2204 is specifically configured to:

acquire a road width between the lane edge line pair, and acquire a lane width corresponding to the first road sub-segment;

when it is determined that the first road sub-segment includes at least two lanes, determine a quantity t of lane dividing lines according to the road width and the lane width, where t is an integer greater than or equal to 1;

insert t lane dividing lines between the lane edge line pair at equal distance, where the t lane dividing lines are parallel to the lane edge line pair.

In a possible implementation, if there is a lane dividing line between the lane edge line pair, the second completing module 2204 is specifically configured to:

extend, according to the second curvature information of the lane edge line pair, the lane dividing line from breakpoints of the lane dividing line until extension lines of two breakpoints of the lane dividing line are connected to each other, or until extension lines of the breakpoints of the lane dividing line are flush with an edge of the lane edge line corresponding to the first road sub-segment.

In a possible implementation, the second completing module 2204 is specifically configured to:

acquire n first lane dividing lines with breakpoints located in the front of the second road sub-segment, and acquire m second lane dividing lines with breakpoints located in the rear of the second road sub-segment, according to the travelling direction of the road, where n and m are integers greater than or equal to 1;

determine corresponding relationships between the n first lane dividing lines and the m second lane dividing lines;

connect a first lane dividing line and a second lane dividing line that have a corresponding relationship from breakpoints, to complete the lane dividing line to obtain a continuous lane dividing line.

In a possible implementation, the second completing module 2204 is specifically configured to:

if the first quantity n is less than the second quantity m, divide the m second lane dividing lines sequentially into n groups according to a direction from outside of the road to inside of the road, where there is a corresponding relationship between the a-th group of the second lane dividing lines and the a-th one of the first lane dividing lines, and a value of a includes 1 to n;

where, in the first n-1 groups of the n groups of the second lane dividing lines, a quantity of the second lane dividing lines is x, and in the n-th group of the n groups of the second lane dividing lines, a quantity of the second lane dividing lines is y, where x is a value obtained by rounding up a ratio of m to n, and y is a value obtained by rounding down a ratio of m to n; or,

if the first quantity n is greater than or equal to the second quantity m, divide the n first lane dividing lines sequentially into m groups according to a direction from inside of the road to outside of the road, where there is a corresponding relationship between the b-th group of the second lane dividing lines and the b-th one of the first lane dividing lines, and a value of b includes 1 to m;

where, in the first m-1 groups of the m groups of the first lane dividing lines, a quantity of the first lane dividing lines is p, and in the m-th group of the m groups of the first lane dividing lines, a quantity of the first lane dividing lines is q, where p is a value obtained by rounding down a ratio of n to m, and q is a value obtained by rounding up a ratio of n to m;

In a possible implementation, the second completing module 2204 is specifically configured to:

determine a fused image of the road according to the point cloud data of the road and the image information of the road;

extract the lane edge line of the road and the lane dividing line of the road from the fused image.

In a possible implementation, the processing module 2201 is further configured to:

display a completed part of the lane dividing line in a first preset style in the fused image, and display a completed part of the lane edge line in a second preset style in the fused image.

The present disclosure provides a method and an apparatus for processing a lane line, which can be applied to the fields of intelligent transportation, Internet of Vehicles and intelligent cockpit in the field of data processing, to achieve the purpose of shortening the consumed time for generating a complete high-definition map.

In the technical solutions of the present disclosure, collection, storage, use, processing, transmission, provision, disclosure and other processing for the user's personal information involved all comply with the relevant laws and regulations, and do not violate public order and customs.

According to embodiments of the present disclosure, the present disclosure also provides an electronic device, a readable storage medium, and a computer program product.

According to an embodiment of the present disclosure, the present disclosure also provides a computer program product, and the computer program product includes: a computer program, which is stored in a readable storage medium. At least one processor of an electronic device can read the computer program from the readable storage medium, and the at least one processor executes the computer program to cause the electronic device to execute the solution according to any one of the foregoing embodiments.

FIG. 23 shows a schematic block diagram of an example electronic device 2300 that can be used to implement the embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital assistant, a cellular phone, a smart phone, a wearable device, and other similar computing devices. The components shown herein, their connections and relationships, and their functions are merely examples, and are not intended to limit implementations of the present disclosure described and/or claimed herein.

As shown in FIG. 23, the device 2300 includes a computing unit 2301, which may execute suitable actions and processing according to computer programs stored in a read-only memory (ROM) 2302 or computer programs loaded into a random access memory (RAM) 2303 from a storage unit 2308. In the RAM 2303, various programs and data required for the operation of the electronic device 2300 can also be stored. The computing unit 2301, the ROM 2302 and the RAM 2303 are connected to each other through a bus 2304. An input/output (input/output, I/O) interface 2305 is also connected to the bus 2304.

Multiple components in the device 2300 are connected to the I/O interface 2305, including: an input unit 2306, such as a keyboard, a mouse, etc.; an output unit 2307, such as various types of displays, speakers, etc.; and a storage unit 2308, such as a magnetic disk, an optical disk, etc.; and a communication unit 2309, such as a network card, a modem, a wireless communication transceiver, etc. The communication unit 2309 allows the device 2300 to exchange information/data with other devices through a computer network such as the Internet and/or various telecommunication networks.

The computing unit 2301 may be various general and/or special processing components with processing and computing capabilities. Some examples of the computing unit 2301 include, but are not limited to, a central processing unit (CPU), a graphics processing unit (GPU), various types of dedicated artificial intelligence (AI) computing chips, various types of computing units that run machine learning model algorithms, and a digital signal processor (DSP), and any appropriate processor, controller, microcontroller, etc. The computing unit 2301 executes the various methods and processing described above, for example, the method for processing a lane line. For example, in some embodiments, the method for processing a lane line may be implemented as a computer software program, which is tangibly contained in a machine-readable medium, such as the storage unit 2308. In some embodiments, part or all of the computer programs may be loaded and/or installed on the device 2300 via the ROM 2302 and/or the communication unit 2309. When the computer programs are loaded into the RAM 2303 and executed by the computing unit 2301, one or more steps of the method for processing a lane line described above can be executed. Alternatively, in other embodiments, the computing unit 2301 may be configured to perform the method for processing a lane line in any other suitable manner (for example, by means of a firmware).

The various implementations of the systems and technologies described herein can be implemented in digital electronic circuit systems, integrated circuit systems, field programmable gate arrays (FPGAs), application specific integrated circuits (ASICs), application specific standard products (ASSPs), system-on-chip (SOC), complex programmable logic devices (CPLDs), computer hardware, firmware, software, and/or the combinations thereof. These various implementations may include: being implemented in one or more computer programs that can be executed and/or interpreted on a programmable system including at least one programmable processor. The programmable processor may be a special or general programmable processor, and can receive data and instructions from a storage system, at least one input apparatus and at least one output apparatus, and transmit data and instructions to the storage system, the at least one input apparatus and the at least one output apparatus.

The program code used to implement the method of the present disclosure can be written in any combination of one or more programming languages. These program codes can be provided to a processor or controller of a general computer, a special computer, or other programmable data processing apparatuses, so that when the program codes are executed by the processor or controller, the functions/operations specified in the flowcharts and/or block diagrams are implemented. The program code can be executed entirely on a machine, partly on a machine, partly executed on a machine as an independent software package and partly executed on a remote machine, or entirely executed on a remote machine or server.

In the context of the present disclosure, a machine-readable medium may be a tangible medium, which may include or store a program for use by, or in combination with, an instruction execution system, apparatus or device. The machine readable medium may be a machine readable signal medium or a machine readable storage medium. The machine-readable medium may include, but is not limited to, an electronic, magnetic, optical, electromagnetic, infrared or semiconductor system, apparatus or device, or any suitable combination thereof. More specific examples of the machine-readable storage medium may include electrical connections with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

To provide interaction with users, the systems and techniques described herein can be implemented on a computer which has: a display apparatus (e.g., a CRT (cathode ray tube) or LCD (liquid crystal display) monitor) for displaying information to users; and a keyboard and a pointing apparatus (e.g., a mouse or a trackball) through which users can provide inputs to the computer. Other kinds of apparatuses can also be used to provide interaction with users, for example, a feedback provided to a user can be any form of sensory feedback (e.g., visual feedback, auditory feedback, or tactile feedback); and can receive inputs from users in any form (including acoustic input, voice input or tactile input).

The systems and techniques described herein can be implemented in a computing system including background components (e.g., as a data server), or a computing system including middleware components (e.g., an application server), or a computing system including front-end components (e.g., a user computer with a graphical user interface or a web browser through which users can interact with implementations of the systems and techniques described herein), or a computing system including any combination of such background components, middleware components or front-end components. Components of the system can be connected to each other through digital data communication in any form or medium (e.g., a communication network). Examples of the communication network include: a local area network (LAN), a wide area network (WAN), and the Internet.

A computer system may include a client and a server. The client and server are generally remote from each other and usually interact through a communication network. A relationship between the client and the server is generated by computer programs running on corresponding computers and having a client-server relationship with each other. The server may be a cloud server, also known as a cloud computing server or a cloud host, which is a host product in a cloud computing service system to solve the shortcomings of difficult management and weak business scalability in a traditional physical host and VPS service (Virtual Private Server, or VPS for short). The server may also be a server of a distributed system, or a server combined with a blockchain.

It should be understood that steps can be reordered, added or deleted for the various forms of processes shown above. For example, the steps described in the present disclosure can be executed in parallel, sequentially or in a different order, so long as the desired results of the technical solutions disclosed in the present disclosure can be achieved, which is not limited herein.

The above specific implementations do not constitute a limitation to the protection scope of the present disclosure. It should be understood by those skilled in the art that various modifications, combinations, sub-combinations and substitutions may be performed according to design requirements and other factors. Any modification, equivalent substitution, improvement and others that are made within the spirit and principle of the present disclosure shall be included in the protection scope of the present disclosure.

What is claimed is:

1. A method for processing a lane line, comprising:
obtaining a lane edge line of a road and a lane dividing line of the road according to point cloud data and image information of the road;
acquiring breakpoints of the lane edge line, and acquiring breakpoints of the lane dividing line;
completing the lane edge line according to the breakpoints of the lane edge line, to obtain a continuous lane edge line;
completing the lane dividing line according to the breakpoints of the lane dividing line and the continuous lane edge line, to obtain a continuous lane dividing line.

2. The method according to claim 1, wherein the completing the lane edge line according to the breakpoints of the lane edge line, to obtain the continuous lane edge line comprises:
matching the breakpoints of the lane edge line into multiple breakpoint pairs according to positions of the breakpoints of the lane edge line in the lane edge line, wherein a breakpoint pair comprises a first breakpoint and a second breakpoint, and a lane edge line between the first breakpoint and the second breakpoint is blank;
for any one of the breakpoint pairs, acquiring a first road segment where the first breakpoint is located, and acquiring a second road segment where the second breakpoint is located;
if the first road segment and the second road segment are a same road segment, completing the lane edge line according to the first road segment and the second road segment to obtain a continuous lane edge line.

3. The method according to claim 2, wherein the completing the lane edge line according to the first road segment and the second road segment to obtain the continuous lane edge line comprises:
determining a road segment type of a target road sub-segment, wherein the target road sub-segment is a road sub-segment between the first breakpoint and the second breakpoint in the first road segment, and the road segment type comprises at least one of the following: a straight road segment, a curved road segment;
if the road segment type is the straight road segment, connecting the first breakpoint and the second breakpoint to complete the lane edge line to obtain a continuous lane edge line; or,
if the road segment type is the curved road segment, performing curve fitting according to the first breakpoint and the second breakpoint to obtain a curved segment between the first breakpoint and the second breakpoint; connecting the first breakpoint and the second breakpoint according to the curved segment, to complete the lane edge line to obtain a continuous lane edge line.

4. The method according to claim 3, wherein the performing curve fitting according to the first breakpoint and the second breakpoint to obtain the curved segment between the first breakpoint and the second breakpoint comprises:
acquiring a first road width corresponding to the first breakpoint, and acquiring a second road width corresponding to the second breakpoint;
determining at least one shape reference point according to the first road width and the second road width;
performing curve fitting according to the first breakpoint, the second breakpoint and the shape reference point to obtain the curved segment between the first breakpoint and the second breakpoint.

5. The method according to claim 4, wherein the determining at least one shape reference point according to the first road width and the second road width comprises:
if a difference between the first road width and the second road width is smaller than a preset threshold, determining an intersection point of an extension line of a part of the lane edge line where the first breakpoint is located and an extension line of a part of the lane edge line where the second breakpoint is located as the shape reference point;
if the difference between the first road width and the second road width is greater than or equal to the preset threshold, collecting a first quantity of shape reference points on the part of the lane edge line where the first breakpoint is located, and collecting a second quantity of shape reference points on the part of the lane edge line where the second breakpoint is located.

6. The method according to claim 1, wherein the completing the lane dividing line according to the breakpoints of the lane dividing line and the continuous lane edge line, to obtain the continuous lane dividing line comprises:
for any target road segment in the road, determining a lane edge line pair corresponding to the target road segment according to the continuous lane edge line, wherein the lane edge line pair comprises continuous lane edge lines located on both sides of the target road segment;
acquiring first curvature information of the target road segment, and acquiring second curvature information of the lane edge line pair corresponding to the target road segment;
completing the lane dividing line according to the first curvature information, the second curvature information and the breakpoints of the lane dividing line, to obtain a continuous lane dividing line.

7. The method according to claim 6, wherein the completing the lane dividing line according to the first curvature information, the second curvature information and the breakpoints of the lane dividing line, to obtain the continuous lane dividing line comprises:
determining a part of the target road segment where the second curvature information is the same as the first curvature information as a first road sub-segment, and determining a part of the target road segment where the second curvature information is different from the first curvature information as a second road sub-segment, according to the first curvature information and the second curvature information;
for the first road sub-segment, completing the lane dividing line according to the lane edge line pair and the breakpoints of the lane dividing line, to obtain a continuous lane dividing line;
for the second road sub-segment, completing the lane dividing line according to a travelling direction of the road and the breakpoints of the lane dividing line, to obtain a continuous lane dividing line.

8. The method according to claim 7, wherein if there is no lane dividing line between the lane edge line pair, the completing the lane dividing line according to the lane edge line pair and the breakpoints of the lane dividing line, to obtain the continuous lane dividing line comprises:
acquiring a road width between the lane edge line pair, and acquiring a lane width corresponding to the first road sub-segment;
when it is determined that the first road sub-segment comprises at least two lanes, determining a quantity t of lane dividing lines according to the road width and the lane width, wherein t is an integer greater than or equal to 1;
inserting t lane dividing lines between the lane edge line pair at equal distance, wherein the t lane dividing lines are parallel to the lane edge line pair.

9. The method according to claim 7, wherein if there is a lane dividing line between the lane edge line pair, the completing the lane dividing line according to the lane edge line pair and the breakpoints of the lane dividing line, to obtain the continuous lane dividing line comprises:
extending, according to the second curvature information of the lane edge line pair, the lane dividing line from the breakpoints of the lane dividing line until extension lines of two breakpoints of the lane dividing line are connected to each other, or until extension lines of the breakpoints of the lane dividing line are flush with an edge of the lane edge line corresponding to the first road sub-segment.

10. The method according to claim 7, wherein the completing the lane dividing line according to the travelling direction of the road and the breakpoints of the lane dividing line, to obtain the continuous lane dividing line comprises:
acquiring n first lane dividing lines with breakpoints located in the front of the second road sub-segment, and acquiring m second lane dividing lines with breakpoints located in the rear of the second road sub-segment, according to the travelling direction of the road, wherein n and m are integers greater than or equal to 1;
determining corresponding relationships between the n first lane dividing lines and the m second lane dividing lines;
connecting a first lane dividing line and a second lane dividing line that have a corresponding relationship from breakpoints, to complete the lane dividing line to obtain a continuous lane dividing line.

11. The method according to claim 10, wherein the determining the corresponding relationships between the n first lane dividing lines and the m second lane dividing lines comprises:
if n is less than m, dividing the m second lane dividing lines sequentially into n groups according to a direction from outside of the road to inside of the road, wherein there is a corresponding relationship between an a-th group of the second lane dividing lines and an a-th one of the first lane dividing lines, and a value of a comprises 1 to n;
wherein, in first n-1 groups of then groups of the second lane dividing lines, a quantity of the second lane dividing lines is x, and in an n-th group of the n groups of the second lane dividing lines, a quantity of the second lane dividing lines is y, wherein x is a value obtained by rounding up a ratio of m to n, and y is a value obtained by rounding down a ratio of m to n; or,
if n is greater than or equal to m, dividing the n first lane dividing lines sequentially into m groups according to a direction from inside of the road to outside of the road, wherein there is a corresponding relationship between a b-th group of the second lane dividing lines and a b-th one of the first lane dividing lines, and a value of b comprises 1 to m,
wherein, in first m-1 groups of the m groups of the first lane dividing lines, a quantity of the first lane dividing lines is p, and in an m-th group of the m groups of the first lane dividing lines, a quantity of the first lane dividing lines is q, wherein p is a value obtained by rounding up a ratio of n to m, and q is a value obtained by rounding down a ratio of n to m.

12. The method according to claim 1, wherein the obtaining the lane edge line of the road and the lane dividing line of the road according to the point cloud data and the image information of the road comprises:
determining a fused image of the road according to the point cloud data of the road and the image information of the road;
extracting the lane edge line of the road and the lane dividing line of the road from the fused image.

13. The method according to claim 12, further comprising:
displaying a completed part of the lane dividing line in a first preset style in the fused image, and displaying a completed part of the lane edge line in a second preset style in the fused image.

14. An apparatus for processing a lane line, comprising:
at least one processor; and
a memory communicatively connected to the at least one processor; wherein,
the memory stores instructions executable by the at least one processor, and the instructions are executed by the at least one processor, so that the at least one processor is configured to:
obtain a lane edge line of a road and a lane dividing line of the road according to point cloud data and image information of the road;
acquire breakpoints of the lane edge line, and acquire breakpoints of the lane dividing line;
complete the lane edge line according to the breakpoints of the lane edge line, to obtain a continuous lane edge line;
complete the lane dividing line according to the breakpoints of the lane dividing line and the continuous lane edge line, to obtain a continuous lane dividing line.

15. The apparatus according to claim 14, wherein the at least one processor is specifically configured to:
match the breakpoints of the lane edge line into multiple breakpoint pairs according to positions of the breakpoints of the lane edge line in the lane edge line, wherein a breakpoint pair comprises a first breakpoint and a second breakpoint, and a lane edge line between the first breakpoint and the second breakpoint is blank;
for any one of the breakpoint pairs, acquire a first road segment where the first breakpoint is located, and acquire a second road segment where the second breakpoint is located;
if the first road segment and the second road segment are a same road segment, complete the lane edge line according to the first road segment and the second road segment to obtain a continuous lane edge line.

16. The apparatus according to claim 15, wherein the at least one processor is specifically configured to:
determine a road segment type of a target road sub-segment, wherein the target road sub-segment is a road sub-segment between the first breakpoint and the second breakpoint in the first road segment, and the road segment type comprises at least one of the following: a straight road segment, a curved road segment;
if the road segment type is the straight road segment, connect the first breakpoint and the second breakpoint to complete the lane edge line to obtain a continuous lane edge line; or,
if the road segment type is the curved road segment, perform curve fitting according to the first breakpoint and the second breakpoint to obtain a curved segment between the first breakpoint and the second breakpoint; connect the first breakpoint and the second breakpoint according to the curved segment, to complete the lane edge line to obtain a continuous lane edge line.

17. The apparatus according to claim 16, wherein the at least one processor is specifically configured to:
acquire a first road width corresponding to the first breakpoint, and acquire a second road width corresponding to the second breakpoint;
determine at least one shape reference point according to the first road width and the second road width;
perform curve fitting according to the first breakpoint, the second breakpoint and the shape reference point to obtain the curved segment between the first breakpoint and the second breakpoint.

18. The apparatus according to claim 17, wherein the at least one processor is specifically configured to:
if a difference between the first road width and the second road width is smaller than a preset threshold, determine an intersection point of an extension line of a part of the lane edge line where the first breakpoint is located and an extension line of a part of the lane edge line where the second breakpoint is located as the shape reference point;
if the difference between the first road width and the second road width is greater than or equal to the preset threshold, collect a first quantity of shape reference points on the part of the lane edge line where the first breakpoint is located, and collect a second quantity of shape reference points on the part of the lane edge line where the second breakpoint is located.

19. The apparatus according to claim 14, wherein the at least one processor is specifically configured to:
for any target road segment in the road, determine a lane edge line pair corresponding to the target road segment according to the continuous lane edge line, wherein the lane edge line pair comprises continuous lane edge lines located on both sides of the target road segment;
acquire first curvature information of the target road segment, and acquire second curvature information of the lane edge line pair corresponding to the target road segment;
complete the lane dividing line according to the first curvature information, the second curvature information and the breakpoints of the lane dividing line, to obtain a continuous lane dividing line.

20. A non-transitory computer-readable storage medium, having computer instructions stored thereon, wherein the computer instructions are used to cause a computer to execute:
obtaining a lane edge line of a road and a lane dividing line of the road according to point cloud data and image information of the road;
acquiring breakpoints of the lane edge line, and acquiring breakpoints of the lane dividing line;
completing the lane edge line according to the breakpoints of the lane edge line, to obtain a continuous lane edge line;
completing the lane dividing line according to the breakpoints of the lane dividing line and the continuous lane edge line, to obtain a continuous lane dividing line.
